(19) United States
(12) Patent Application Publication
(10) Pub. No.: US 2023/0382168 A1
(43) Pub. Date: Nov. 30, 2023

(54) MONITORING DEVICE FOR A VEHICLE, WARNING SYSTEM AND METHOD FOR OPERATING A MONITORING DEVICE

(71) Applicant: Helmut SCHROEDEL, Planegg (DE)

(72) Inventors: Helmut SCHROEDEL, Planegg (DE); David Wayne LARSEN, Planegg (DE); Mercurio CICCHINI, Planegg (DE)

(21) Appl. No.: 18/032,180

(22) PCT Filed: Apr. 20, 2021
(86) PCT No.: PCT/EP2021/000049

§ 371 Date: Apr. 16, 2023

(30) Foreign Application Priority Data
Oct. 17, 2020 (DE) 10 2020 006 399.3
Apr. 9, 2021 (DE) 10 2021 001 843.5

(51) Int. Cl. B60C 23/04; B60C 23/20; B60B 27/00

(52) U.S. Cl. CPC B60C 23/0498; B60C 23/20; B60B 27/0068

(57) ABSTRACT

The present invention relates to a monitoring device (100) comprising at least one measuring device with a temperature sensor unit (110) for wheel hub temperature and/or with a tire-pressure sensor unit (1501) and comprising a transmitting unit (115). The tire-pressure sensor unit (1501) is designed to sense a tire pressure of at least one wheel tire of a wheel of the vehicle; more particularly, the tire-pressure sensor unit (1501) is designed to draw electrical energy from the transmitting unit (115), which is external to the tire-pressure sensor unit (1501) and/or is fastened such that the transmitting unit can be spontaneously detached, or to output sensed data to the transmitting unit, and the tire-pressure sensor unit (1501) has a fastening apparatus, which is designed to detachably frictionally attach the tire-pressure sensor unit (1501), in a fastening position, to one or more portions of a wheel hub (120) of the wheel, a hub sleeve (130) of the wheel, a wheel rim (122) and/or a wheel nut (200) of the vehicle. Furthermore, the monitoring device (100) comprises the transmitting unit (115), which can be frictionally attached or fitted onto the wheel hub (120) of the wheel or onto the wheel rim (122) such that the transmitting unit can be spontaneously detached; more particularly, the transmitting unit (115) is designed to wirelessly transmit a sensor signal representing the tire pressure and/or the wheel hub temperature, so that the tire pressure and/or the wheel hub temperature can be monitored.

### STATE OF THE ART

The approach is based on a device or a method according to the preamble of the independent claims.

All known monitoring devices for hub temperature and/or tire pressure on motor vehicle trains are either permanently installed or at least fixedly bolted together and can only be removed requiring tools. A sudden exchange of trailers or the prime mover out of logistical or mechanical reasons, in which the monitoring device remains undisturbed, is not spontaneously possible. Since all modern monitoring systems work electrically and the measuring units mounted to wheels or axles require a power source, they cannot stay in place within danger zones out of explosion protection reasons, if they are not sufficiently explosion-protected or can be easily and quickly removed and therefore do not represent an ignition source in explosive atmospheres, particular in Zone 0 and Zone 1.

### DISCLOSURE

Against this background, the approach presented here provides, for example, an immediately removable monitoring device for a vehicle, a warning system and a method for operating a monitoring device, which allows an immediate system transfer to another motor vehicle train rig and enables a spontaneous exchange of prime moving or towed vehicle components, as well as an immediate removal of the electric power source components which allows the operation in explosive atmospheres, for example, filling the gasoline tanks of a petrol or gas station with a road tanker.

The achievable advantages with the approach here presented are in preventing under all circumstances a tire fire becoming a vehicle fire and provide the possibility to increase the vehicle safety for a driver, a vehicle or vehicle train, by which the driver can monitor the tire pressure of each individual wheel on a screen in the driver's cab in addition to wheel hub or rim temperature for example. A fastening of a monitoring device presented for this purpose on the vehicle can be realized quickly and simply, being solidly mounted, as well as easily releasable again and therefore transferable to another vehicle. For example it is possible in the event of a spontaneous vehicle change due to a logistical event or prior entering explosive atmospheres to remove all current-carrying components of a hazardous material transport for a short time and for example spontaneously manually and/or without tools. In the context of this application, the term “spontaneously releasable” should be understood as being “manually releasable”, “detachable without tools” or “detachable without preliminary setup time/work”, and does not mean that an unintentional release is made possible. The spontaneous release or re-attaching the transmitting unit is an important prerequisite for a spontaneous change regarding logistics and in particular when entering explosive atmospheres having the possibility of the immediate removal of the current-carrying transmission units. A further advantage is that the self-contained system is vehicle-independent and therefore complete maintenance, repair and verification can be carried out at a location independent of the vehicles. A system which is then properly functioning and tested can then be newly applied onto any desired vehicle train or replaced with a system which is due for maintenance.

A monitoring device for a vehicle is presented, wherein the monitoring device has at least one measuring device with a temperature and/or tire pressure sensor unit, which can be accommodated at least partially in a transmission unit. The tire pressure sensor unit is designed to sense a tire pressure of at least one wheel tire of a wheel of the vehicle, wherein the tire pressure sensor unit can be formed without current source. In this case, the necessary electrical energy is obtained from a transmitter unit which is arranged externally and/or is spontaneously detachably fastened by the tire pressure sensor unit, and/or data transmitted thereto is emitted, wherein the tire pressure sensor unit has a fastening device which is designed to fix the tire pressure sensor unit in a fastening position, for example in the central centre point of the wheel in exemplum at the wheel hub end or on one or more sections of a wheel hub of the wheel, of a hub sleeve of the wheel, of a wheel rim and/or wheel nut of the vehicle, and/or wherein the transmitting unit is fastened to the tire pressure sensor unit in a spontaneously releasable manner. The monitoring device further comprises the transmitting unit which, according to one embodiment, is immediately detachably plugged onto the tire pressure sensor unit in the central centre point of the wheel and is snap-fitted or releasable attached to the wheel hub of the wheel or the wheel rim, in particular wherein the transmission unit can be designed to wirelessly transmit a sensor signal representing the hub temperature and/or a sensor signal representing the tire pressure to enable monitoring of the wheel hub temperature and/or the tire pressure.

The temperature and/or tire pressure sensor unit is designed to sense, during travel of the vehicle, the wheel hub temperature and/or the tire pressure of a single wheel or the tire pressure from a wheel with, for example, individual tires, double tires or multiple tires. For reasons of explosion protection in hazardous material and in explosive atmospheres operation, the tire pressure sensor unit advantageously does not have its own power source. The transmitting unit has, for example, its own releasable fastening from the fastening device, wherein the latter is self-formed in an embodiment itself, so that it can be detachably fastened at the end of a wheel hub centrally, eccentrically on the outer wall of the hub sleeve, on a wheel nut or on the surfaces of the wheel rim in the rim interior and/or, for example, is connected to the transmitting unit via an immediately detachable snap-in plug device and/or a data cable which can wirelessly transmit the sensor signal to a warning device in, for example, a driver's cab, in order to enable monitoring of the wheel hub temperatures and/or the tire pressures. The transmission unit can also be referred to as a “monitoring and transmitting unit for wheel hub temperature and/or tire pressure”.

The wheel hub temperature and/or tire pressure monitoring which can be carried out by means of the monitoring device can be used, for example, for vehicles such as semi-trailers with, for example, a plurality of trailers and a plurality of wheels, the so-called road trains. The monitoring device presented here now advantageously enables an automated individual monitoring of the wheel hub temperature and/or the tire pressure of wheels, both with single and double tires.

Both, the wheel hub end, the hub sleeve and the hub flange and the wheel rim are easily accessible to a vehicle driver and the entire monitoring device can thus be quickly and easily attached and removed. The warning device, which is also referred to below as a “tire pressure warning device” or “temperature warning device” or “temperature and tire pressure warning device” can be understood as a receiving device which is arranged or can be arranged in a driver's cabin of the vehicle and which offers a possibility here, after receiving the sensor signal, to be able to monitor the wheel hub temperature and/or the tire pressure in the region of the wheel for the vehicle driver during travel. For example, the transmitting unit can be designed to transmit the sensor signal to the warning device by radio, such as a radio signal. In this case, the transmitting unit can be designed, for example, to send the sensor signal to the warning device in a defined time interval, for example in a one minute cycle, in order to always provide current physical parameters such as wheel hub temperature and/or tire pressure. The wheel hub temperature monitoring device serves to prevent axle fire and/or control of the tire pressure, mainly for the plurality of wheels of a multi-trailer hazardous goods vehicle train, wherein the monitoring device may be configured to be transferred within a few minutes from one vehicle to another vehicle, depending on the logistics requirement, completely or partially and if the monitoring device is not certified for explosion protection, in particular for Zone 1, it can be quickly and easily removed from the relevant vehicle components shortly before entering such a zone with explosive atmospheres.

According to one embodiment, the transmitting unit and the tire pressure sensor unit can be arranged in different housings and/or can be connected to one another or can be connected to one another via a flexible connecting cable for transmitting the physical parameter, such as wheel hub temperature and/or tire pressure. This makes it possible to position the transmitting unit and the tire pressure sensor unit at different points which are advantageous for their function. Additionally or alternatively, the transmitting unit and/or the tire pressure sensor unit can also be arranged in a gas-tight and/or explosion-proof housing. In the present case, an explosion-proof housing can be understood to mean a housing which is designed to be gas-tight, so that, for example, a combustible gas cannot penetrate into the housing and can be ignited by components of the transmitting unit and/or the tire pressure sensor unit. In this way, the monitoring device can in particular also remain attached to hazardous goods transport vehicles in which possibly occurring combustible liquids or vapours can emerge during loading or unloading of the hazardous goods transport vehicle, which then may ignite or initiate an explosion caused by the transmitting unit and/or the tire pressure sensor unit.

If the housings of the transmitting units are not explosion-proof, the transmitting units can advantageously be pulled out of the plug-in device before entering an explosive atmosphere and be accommodated in the driver's cab, similar to the mobile telephone of a vehicle driver, which is also not explosion-proof and has to remain in the driver's cab for this reason.

The fastening device of the tire pressure sensor unit can have parts which are shaped in order to be fastened to a wheel surface of the wheel. For example, the parts can be movably mounted in order to grip a suitable but arbitrarily shaped wheel surface in order to find hold there. The parts can be formed in a finger-like manner, for example in the form of claws or holding claws or adhesive claws, and/or magnetic or adhesive.

The fastening device, which is also referred to below as a “fastening mechanism”, of the tire pressure sensor unit can be shaped in order to mechanically deform the tire pressure sensor unit on the wheel hub of the wheel, at the wheel hub end, of the hub sleeve or on the wheel nut by means of movable adaptation parts in accordance with the contact surface (s) in order to positively fasten the tire pressure sensor unit to the wheel hub of the wheel. The wheel nut can be arranged on the hub flange of the wheel hub and serve, for example, for connecting the wheel hub to the wheel rim. For ideal form-fitting reception at the fastening positions suitable on the wheel, the fastening mechanism can take the form of a hexagonal socket, a flat, curved or angled surface. Such an attachment to the wheel makes it possible to accommodate the tire pressure sensor unit on a plurality of different wheel hubs and the wheel nuts thereof.

According to one embodiment, in addition or as an alternative, at least one region of the fastening device can have at least one magnet in order to fasten the tire pressure sensor unit magnetically to the wheel hub, hub sleeve, wheel rim and/or wheel nut and/or the fastening device can have a binding device which is designed to additionally tighten the tire pressure sensor unit on the wheel hub, hub sleeve, wheel rim and/or wheel nut. Furthermore, a magnetic and/or force-locking connection can be realized between the tire pressure sensor unit and the wheel in order to increase the stability of the tire pressure sensor unit on the wheel. The fastening device can also have a plurality of magnets, for example strong magnets. For example, the fastening mechanism can adapt magnetically, so that this pulls magnetically into a correct position via the wheel nut at the wheel hub end or hub sleeve for a particularly simple assembly during attachment. The binding device can be shaped so as to counteract the centrifugal force when fastening to the hub sleeve.

According to one embodiment, the fastening mechanism can have one or more, for example three, movable holding or adhesive claws. The adhesive claws can form together the hexagonal socket, or can adapt to a flat, curved or angled surface. For non-magnetic substrates, touching fastening surfaces can be connected by an industrial foam adhesive tape or adhesive compound on both sides, since a fastening mechanism can remain semi-permanently on the vehicle. In the case of eccentric attachment, the imbalance can optionally be balanced with a counterweight and is to be taken into account in particular in the case of steering wheels. It is advantageous here to provide an attachment in the hub centre with negligible centrifugal force.

It is advantageous, if the fastening device adjoins a pressure housing, in the interior of which a pressure sensor is located, also referred to as a “pressure chamber”. The pressure housing can be part of the tire pressure sensor unit and, for example, be closed in an air-tight manner. Thus, the tire pressure sensor unit can carry the pressure sensor, which is exposed to the pressure chamber, which itself is exposed to the tire pressure, in an airtight manner with respect to the atmospheric air pressure, in order to sense the tire pressure via, for example, a connecting hose to a valve stud of the wheel tire. According to one embodiment, the pressure sensor can be connected or connectable to a hose via a valve stem of at least one wheel tire of the wheel in order to sense the pressure of at least the wheel. As a result, the pressure sensor is in operation under the tire pressure of the wheel and senses the pressure of at least one wheel. Knowledge about the tire pressure can serve to prevent a safety-critical low or safety-critical high tire pressure and can positively influence the service life of a tire with correct pressure.

The pressure sensor and/or the interior chamber can also be connected or can be connected in each case by one hose to one of at least two wheel tires each having a wheel valve stem, in particular wherein the pressure sensor can be designed to sense a tire pressure which equalizes between at least the two wheel tires.

It is advantageous in this case to connect the second wheel tire to the same pressure chamber interior of the tire pressure sensor unit by means of a second connecting hose and/or additionally to provide the pressure chamber with a pressure housing valve stem as an inflation valve in the case of double tires on a wheel, so that both tires are inflated simultaneously and the pressure which equalizes between the tires can be measured. It is therefore advantageous if the monitoring device according to one embodiment has at least one pressure housing valve stem through which air can be supplied to at least one wheel tire. Thus, in each case one hose can lead from the chamber to one of the wheel valve stems of at least two wheel tires and additionally or alternatively, air can be pumped via a valve into the pressure housing via the air-tight fitted pressure housing valve stem. At the same time, at least two connected tires are inflated simultaneously.

It is furthermore advantageous if the monitoring device has a data plug connection or a data cable between the temperature and/or tire pressure sensor unit and the transmitting unit, wherein both sensor units are designed to send a respective sensor data signal via a respective data cable to the transmission unit, and/or the transmitting unit is designed to output electrical energy via the data cables to the sensor units. According to an embodiment for steering wheels, the temperature and tire pressure sensor unit can be located together with the transmission unit in a single housing and can be non-detachably connected via an internal data cable or alternatively be detachably connected or connectable in two separate housings by means of, for example, only one or two plug connections on one or both of the housings or in the cable. The monitoring device may further comprise a plug-in device which is designed to detachably couple the tire pressure sensor unit and/or the temperature sensor unit to the transmitting unit, in particular wherein the plug-in device can be formed as a self-locking plug-in device. The plug-in device can be part of the fastening device.

Furthermore, a warning system is presented which has the monitoring device in one of the variants described above and a warning device which is designed to receive the sensor signal and to generate a warning signal when temperature or tire pressure reaches a defined threshold value. The warning device can be arranged or can be arranged, for example, in a driver's cab of the vehicle. The warning signal can be designed to have an acoustical, optical and/or haptic warning effect for a person on, for example, an output unit of the warning device. This can ensure that the vehicle driver is made aware of a critical value. Such a warning system advantageously offers a possibility of completely monitoring the operating state of at least one vehicle wheel, by which the output of the measured values informs the vehicle driver.

Furthermore, a method for operating a monitoring device in one of the variants described above is presented. The method comprises a step of sensing and a step of sending. In the sensing step, the temperature, for example the wheel hub temperature, in the region of the wheel is determined using the temperature sensor unit, which is at least partially fastened to the wheel hub during travel of the vehicle and is passed on to the transmitting unit. Additionally or alternatively, in the sensing step, the tire pressure of at least one wheel tire of a wheel is sensed using the tire pressure sensor unit, which in the attachment position is releasable attached to the wheel hub (s) of the wheel, hub sleeve of the wheel, wheel rim and/or wheel nut of the vehicle in particular wherein, in the sensing step, the electrical energy is obtained from the transmitter unit arranged externally by the tire pressure sensor unit. In the transmission step, the sensor signal representing the tire pressure and/or the temperature is transmitted using the transmission unit, which is fastened to the wheel hub or the wheel rim of the wheel or the tire pressure sensor unit in a spontaneously releasable manner to enable monitoring of the wheel hub temperature and/or the tire pressure.

Exemplary embodiments of the approach presented here are illustrated in the drawings and explained in more detail in the following description.

### BRIEF DESCRIPTION OF THE DRAWINGS

FIG. 1 shows a perspective illustration of an exemplary embodiment of a monitoring device for a vehicle, for example for measuring the wheel hub temperature and at the same time the tire pressure of two separate tires with identical rims on a wheel hub, are mounted back to back and are referred to as double or twin tires;

FIG. 1a shows a perspective illustration of an exemplary embodiment of a monitoring device;

FIG. 2 shows a perspective illustration of a tire pressure sensor unit according to an exemplary embodiment;

FIG. 3 shows a perspective illustration of a tire pressure sensor unit without connecting hoses to the valve stems according to an exemplary embodiment;

FIG. 4 shows a perspective view of a tire pressure sensor unit laterally from below with the fastening mechanism of three adhesive claws, one of which is folded downwards without connecting hoses to the valve stems according to one exemplary embodiment;

FIG. 4a shows a perspective view of a cable plug connection for a monitoring device according to an exemplary embodiment;

FIG. 5 shows a perspective illustration of a tire pressure sensor unit with the fastening mechanism of three adhesive claws, wherein an adhesion claw, broken down into its components, is illustrated according to an exemplary embodiment;

FIG. 6 is a perspective view of a pressure sensor housing block separate from the attachment mechanism with three exposed magnets in the centre according to one embodiment;

FIG. 7 shows a perspective view of a disassembled tire pressure sensor unit according to an exemplary embodiment;

FIG. 8 shows a perspective illustration of the pressure sensor housing block with an exposed pressure sensor according to an exemplary embodiment;

FIG. 8a shows a perspective illustration of the pressure sensor housing block with an exposed pressure chamber according to an exemplary embodiment;

FIG. 9 shows a perspective illustration of a plugged-in transmission unit according to an exemplary embodiment;

FIG. 10 shows a perspective illustration of the transmission unit unplugged from the tire pressure sensor unit, which adheres magnetically to the wheel hub, presented as an exemplary embodiment;

FIG. 10a shows a perspective illustration of a plug-in device with a snap lock, shown in accordance with an exemplary embodiment;

FIG. 11 shows a perspective illustration of a transmission unit according to an exemplary embodiment;

FIG. 11a shows a perspective illustration of a transmitting unit according to an exemplary embodiment;

FIG. 12 is a perspective view of a wheel with a fixedly installed tachometer at the hub cap end by the manufacturer, thereby necessarily allowing a possible adhesive attachment to the monitoring device on a wheel nut if a constant readability is desired, according to an exemplary embodiment;

FIG. 13 shows a cut-open illustration of a monitoring device on a wheel nut with claw-encompassing adhesive fastening shown in detail according to an exemplary embodiment;

FIG. 14 is a perspective view of a counterweight for balancing the resulting imbalance due to the attachment of the monitoring device to the wheel nut according to an exemplary embodiment;

FIG. 15 shows a perspective view of a disassembled counterweight according to an exemplary embodiment;

FIG. 16 shows a lateral cross-sectional view of a fixing device of a counterweight according to an exemplary embodiment;

FIG. 16a shows a lateral cross-sectional view of a fixing device of a counterweight according to an exemplary embodiment;

FIG. 17 shows a perspective illustration of a fixing device according to one exemplary embodiment;

FIG. 17a shows a perspective view of a detail of a clamping device according to an exemplary embodiment;

FIG. 17b shows a perspective illustration of a clamping device with clamped wheel nut, according to an exemplary embodiment;

FIG. 18 shows a perspective view of a disassembled temperature sensor unit of a monitoring device according to an exemplary embodiment;

FIG. 19 shows a perspective illustration of an exemplary embodiment of a warning device for a vehicle;

FIG. 19a shows a perspective illustration of the components of a base station of a warning device according to an exemplary embodiment;

FIG. 20 shows an output unit for use with a warning system according to an exemplary embodiment;

FIG. 21 shows a schematic plan view of a vehicle with a monitoring device according to an exemplary embodiment;

FIG. 21a shows a schematic side view of a vehicle with a monitoring device according to an exemplary embodiment;

FIG. 22 shows a schematic representation of a vehicle with a warning system according to an exemplary embodiment;

FIG. 23 shows a flow chart of a method according to an exemplary embodiment for operating a monitoring device;

FIGS. 24, 24a to 24g each show a fastening device of a monitoring device according to an exemplary embodiment;

FIGS. 25 and 25a each show a perspective view of a monitoring device according to an exemplary embodiment;

FIG. 26 shows a perspective illustration of a monitoring device according to an exemplary embodiment;

FIG. 27 shows a perspective illustration of a monitoring device according to an exemplary embodiment;

FIG. 27a shows a perspective illustration of a monitoring device according to an exemplary embodiment;

FIG. 28 shows a perspective illustration of a deep wheel hub temperature measuring unit according to an exemplary embodiment; and

FIG. 28a shows a perspective illustration of a deep wheel hub temperature measuring unit according to an exemplary embodiment.

In the following description of advantageous exemplary embodiments of the present approach, identical or similar reference signs are used for the elements shown and acting in a similar manner in the various figures, wherein a repeated description of these elements is dispensed with.

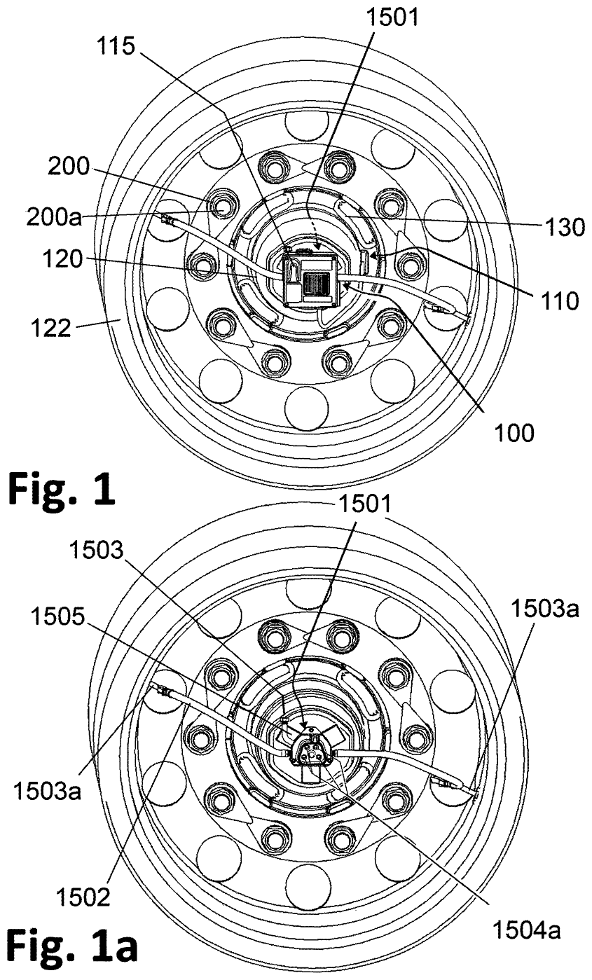

FIG. 1 shows a perspective illustration of an exemplary embodiment of a monitoring device 100 for a vehicle with exemplary double tires of the wheels. According to this exemplary embodiment, the monitoring device 100, which can also be referred to as a “wheel hub temperature and/or tire pressure monitoring device”, is designed in such a way that a temperature measurement of the hubs is made possible and as an additional expansion, a tire pressure measurement of the twin tires is added in the transmission unit 115.

The monitoring device 100 has at least one measuring device with a temperature sensor unit 110 and/or a tire pressure sensor unit 1501 and a transmission unit 115. The tire pressure sensor unit 1501, shown in FIG. 1a to FIG. 8a, is designed to sense a tire pressure of at least one wheel tire of a wheel of the vehicle, wherein the tire pressure sensor unit 1501 according to an exemplary embodiment can furthermore be designed to draw electrical energy from the transmitter unit 115, which is arranged externally and/or spontaneously releasable fastened by the tire pressure sensor unit 1501, and/or to output data transmitted thereto, wherein the

tire pressure sensor unit 1501 has a fastening device, illustrated in FIG. 1a to FIG. 8, which is shaped to fasten the tire pressure sensor unit 1501 in a fastening position shown here releasable to one or more sections of a wheel hub 120 of the wheel, a hub sleeve 130 of the wheel, a wheel rim 122 and/or wheel nut 200 of the vehicle. The monitoring device 100 has the transmission unit 115, which can be fastened to the wheel hub 120 of the wheel, the wheel rim 122 or, as shown here in FIG. 1, to the tire pressure sensor unit (1501) in a spontaneously releasable manner, in this case, for example, by a plug-in device, wherein the transmitting unit 115 can be designed according to an exemplary embodiment in order to wirelessly transmit a sensor signal representing the wheel hub temperature and/or the tire pressure to enable monitoring of the wheel hub temperature and/or the tire pressure.

The temperature sensor unit 110 of the monitoring device 100 is designed to be able to be fastened mainly to the wheel hub 120 and to sense a temperature in the region of the wheel during travel of the vehicle and to provide it to the transmitting unit 115 in order to enable the monitoring of the wheel hub temperature.

According to this exemplary embodiment, the tire pressure sensor unit 1501, transmitter unit 115 and/or temperature sensor unit 110 are each arranged in different housings. According to this exemplary embodiment, the tire pressure sensor unit 1501 is fastened to a hub centre of the wheel hub 120. According to this exemplary embodiment, the transmitting unit 115 is placed on the tire pressure sensor unit 1501 located in the hub centre, so that the tire pressure sensor unit 1501 and the transmitting unit 115 are fastened on top of one another on the hub centre of the wheel hub 120.

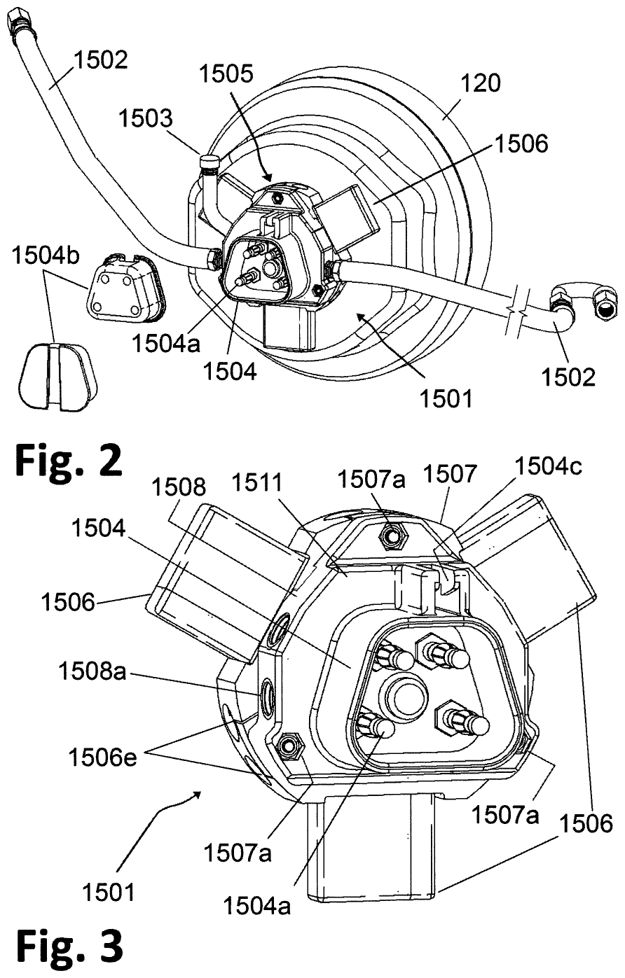

FIG. 1a shows a perspective illustration of an exemplary embodiment of a monitoring device. The exemplary embodiment described in FIG. 1 is the exemplary embodiment described in FIG. 1, wherein the transmission unit having an integrated temperature probe has been unplugged and removed in order, for example, to allow for operation in an explosive atmosphere or to apply the transmission unit to another wheel unit of a vehicle provided for the exchange, wherein the illustrated tire pressure sensor unit 1501 remains connected to the valves with the wheel staying back. One can observe here, according to this exemplary embodiment, the fastening device 1505, an air pressure hose 1502, a pressure housing valve stem 1503, a wheel valve stem 1503a of the rim and a pin plug, which is also referred to below as a “pressure housing plug connection”, with tuft pins 1504a, which are described in more detail in FIG. 2.

FIG. 2 shows a perspective illustration of an exemplary embodiment of a tire pressure sensor unit 1501, which can also be referred to as a “tire pressure monitoring sensor unit” for a vehicle. This can be the tire pressure sensor unit 1501 of the monitoring device 100 described with reference to FIG. 1 or 1a, which, as described in FIG. 1, adheres to the wheel hub 120 in the ready-to-use state, for example adheres magnetically and/or adhesively. The tire pressure sensor unit 1501 is shown laterally from the front right, with its fastening device 1505, which here has, by way of example, three spread-out adhesion claws 1506, and with connecting air pressure hoses 1502 to the wheel valve stems.

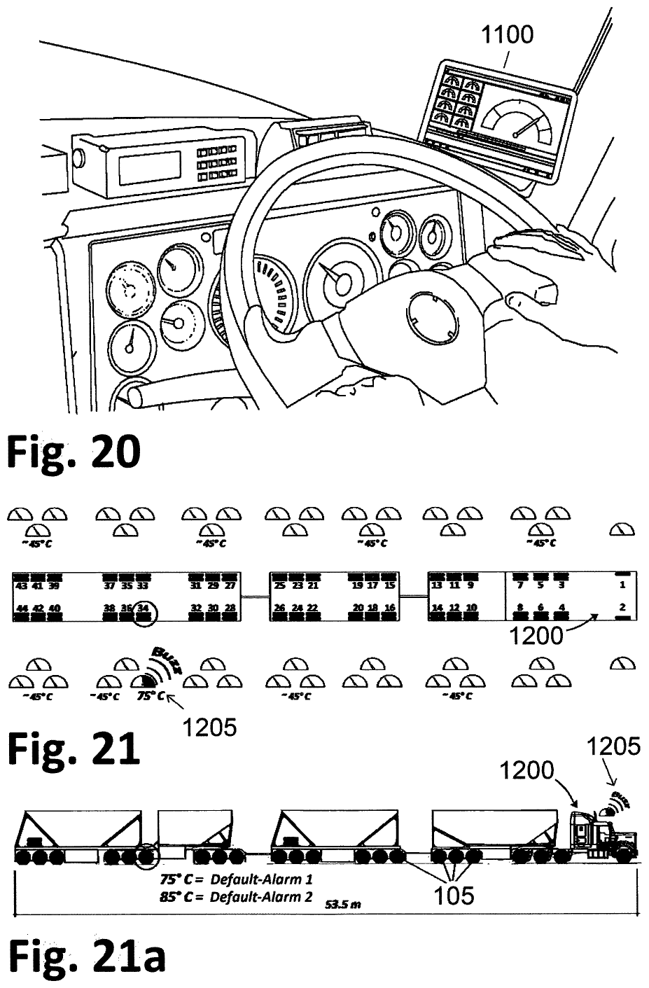

According to this exemplary embodiment, the tire pressure sensor unit 1501 is provided with one or two connected metal braided air pressure hoses 1502 and the pressure housing valve stem 1503, which accommodates an inflation valve for a single tire or a double tire. Four robust tuft pins 1504a, which function simultaneously as a mechanical fastening by an immediately detachable, securely locked plug-in connection with the transmitting unit 115, transfer, in an application example of the monitoring device, the tire pressure data measured by the tire pressure sensor unit 1501 to the transmission unit shown in FIG. 1. This transmits the tire pressure data together with the wheel hub temperature to a base station shown in FIG. 19 located in the driver's cab. These measurements are further processed there into an audio-visual screen perception for the protection of the vehicle driver and can additionally be uploaded to the mobile radio network in real time if a screen remote monitoring is desired via the output unit shown in FIG. 20.

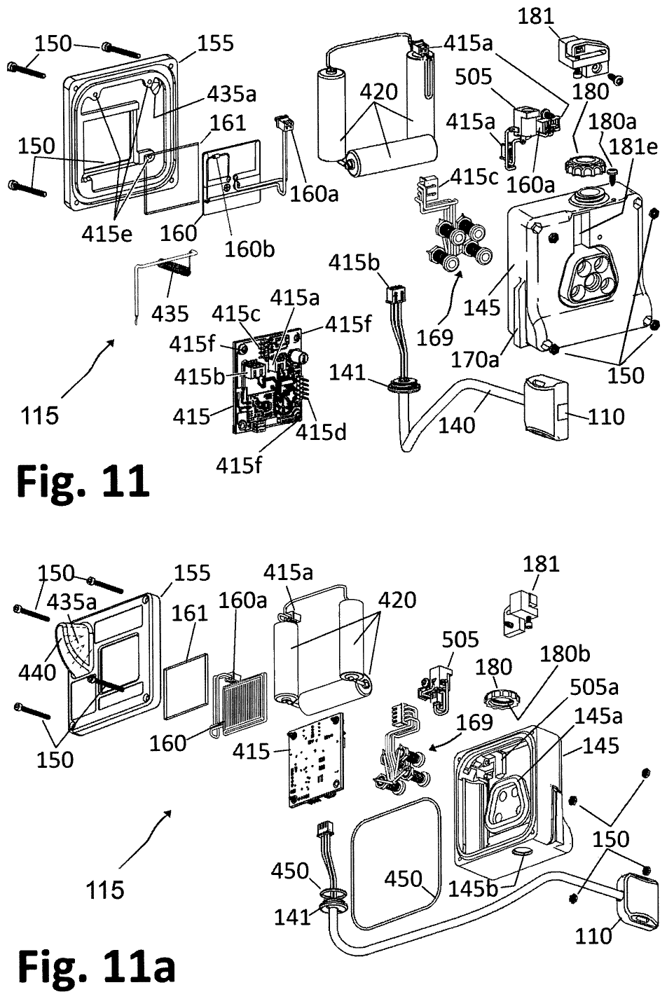

In the case of vehicles left behind, a plug-on cap 1504b protects the contact surfaces of the tuft pins 1504a from weathering. The protective cap 1504b is carried along on the housing of the monitoring and transmitting unit 115, pushed and jammed onto the wedge-shaped retaining rail 170a shown in FIG. 11.

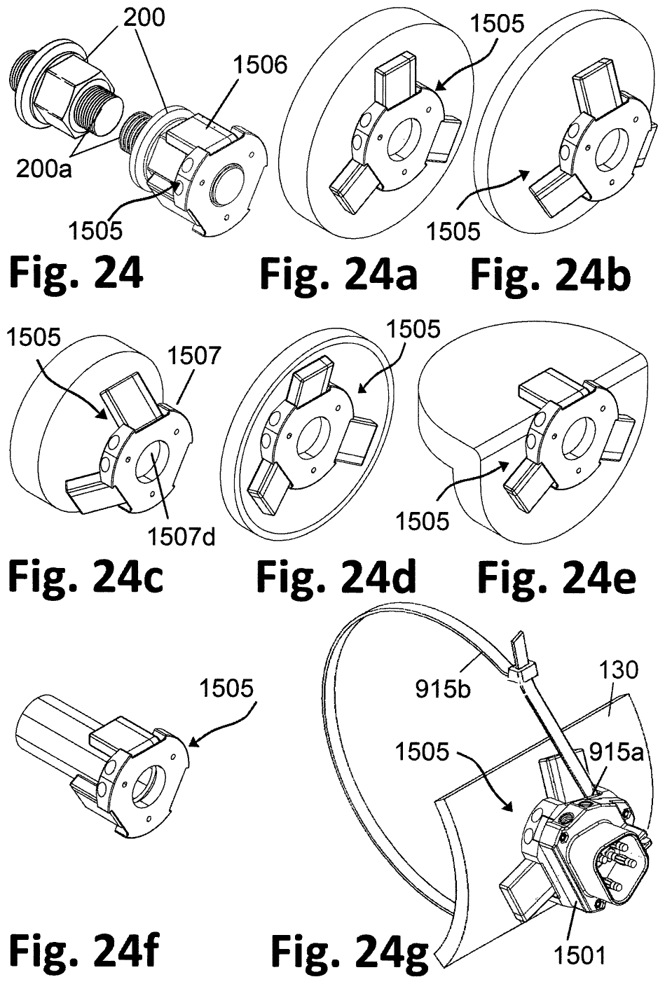

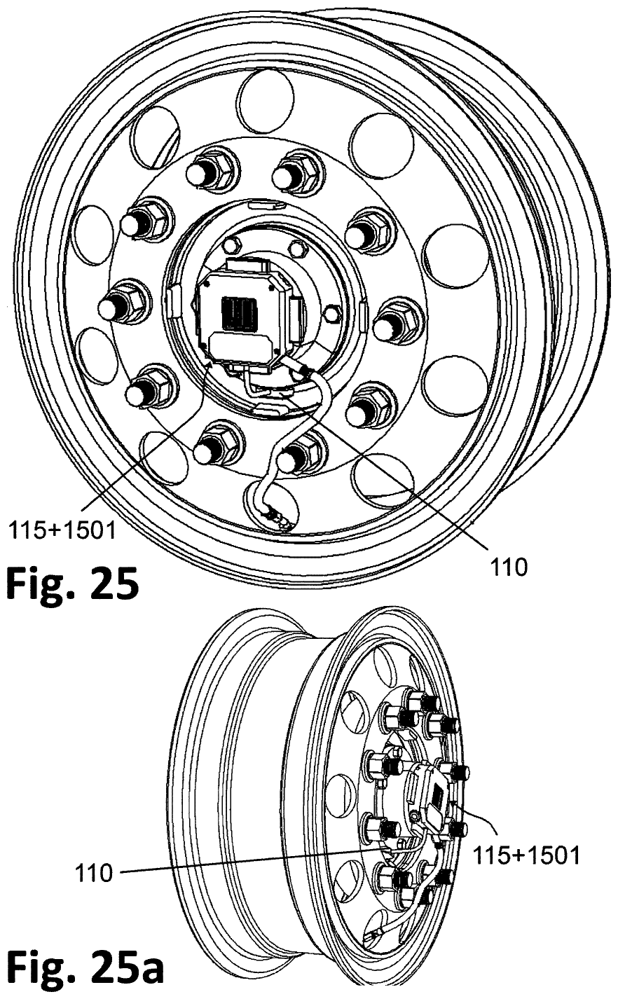

The fastening mechanism of the fastening device 1505 in FIG. 1a to FIG. 8 of the tire pressure sensor unit 1501 permits positioning on different and differently shaped attachment points on the wheel hub, on a wheel nut or wheel rim, illustrated by the mounting positions for differently designed surfaces, as shown in FIG. 24 and FIG. 24a-24g.

FIG. 3 shows a perspective illustration of a tire pressure sensor unit 1501 without connecting hoses to the valve stems, according to one exemplary embodiment. This can be a more accurate representation of the tire pressure sensor unit 1501 described in FIG. 2, laterally from the front left, with its fastening device 1505 and three spread-out adhesion claws 1506.

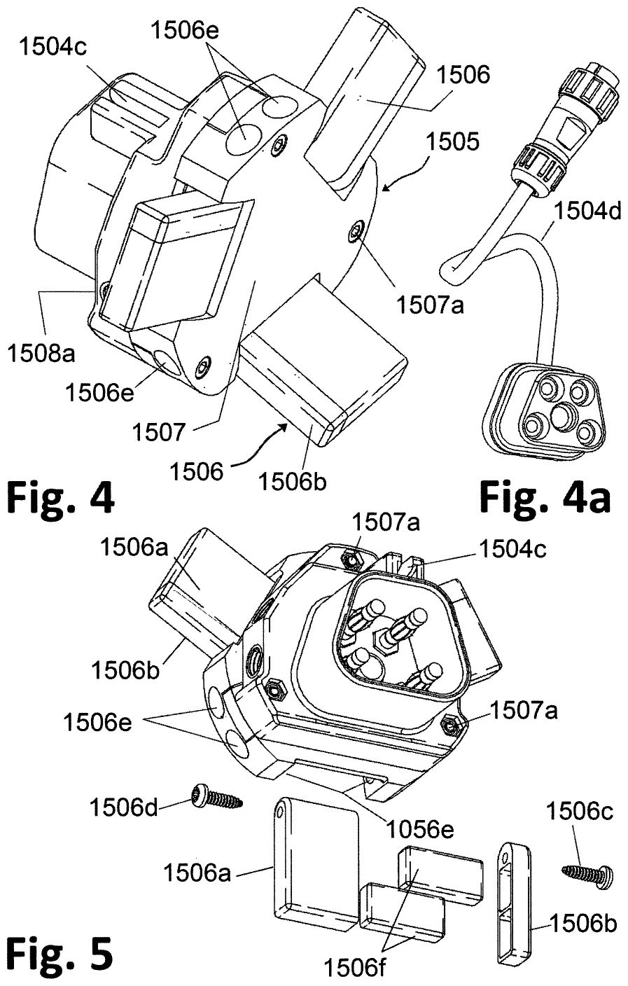

FIG. 4 shows a perspective view of a tire pressure sensor unit laterally from below with the fastening mechanism of three adhesion claws 1506, one of which is folded downwards without connecting hoses to the valve stems, according to one exemplary embodiment. This can be the tire pressure sensor unit described in one of the preceding figures.

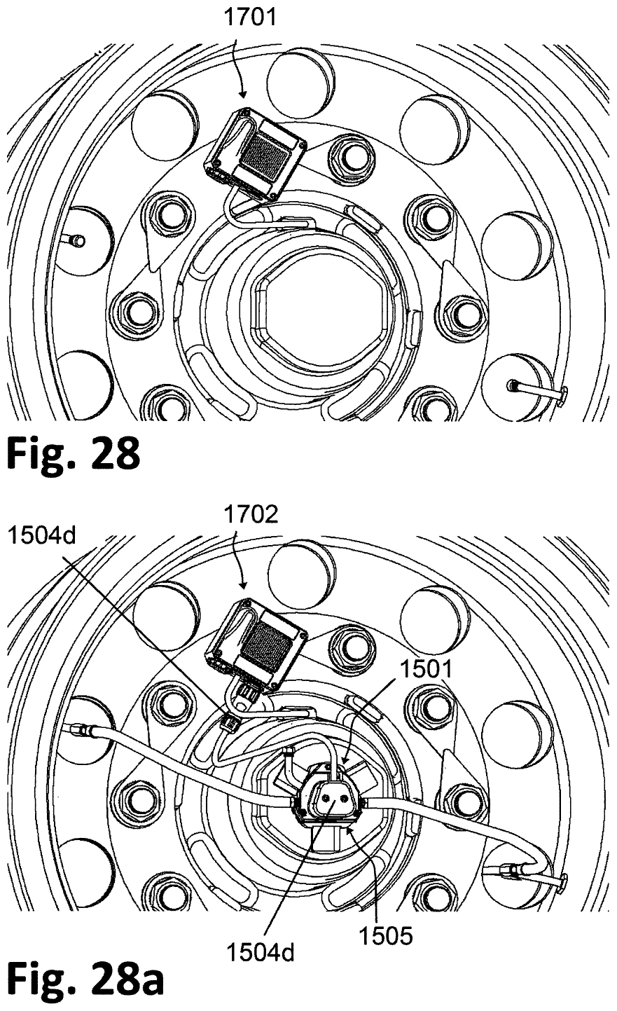

FIG. 4a shows a perspective view of a cable plug connection 1504d for a monitoring device according to an exemplary embodiment. According to one exemplary embodiment, the cable plug connection 1504d is part of the monitoring device and/or for mechanically connecting a transmission unit of a different type, which is positioned outside the hub centre, to the tire pressure sensor unit; see also FIG. 28a for this purpose. Cable plug connection 1504d is a data cable according to one exemplary embodiment.

FIG. 5 shows a perspective view of a tire pressure sensor unit with the fastening mechanism of three adhesion claws 1506, wherein an adhesion claw, broken down into its components, is shown according to an exemplary embodiment. This can be the tire pressure sensor unit described in one of the preceding figures. In FIG. 5, a pivoting adhesion claw 1506 is removed from the bearing and disassembled into its individual parts. The housing consists of a claw housing 1506a and a claw housing cover 1506b. A cutting screw 1506c holds the two housing parts together and also serves as a pivot bearing on one side of the claw, while the cutting screw 1506d forms the pivot bearing on the other side. Both screw heads of the two cutting screws 1506c and 1506d in FIG. 5 and FIG. 7 also prevent a falling out of the bearing holes 1506e after the two screws have been inserted through the bearing holes 1506e and screwed into the two housing parts. An adhesion claw 1506 can therefore only be removed from its seating when both cutting screws 1506c and 1506d are removed. Two neodymium magnets 15061, poled in mutual attraction, are accommodated in the claw housing and divided into two chambers.

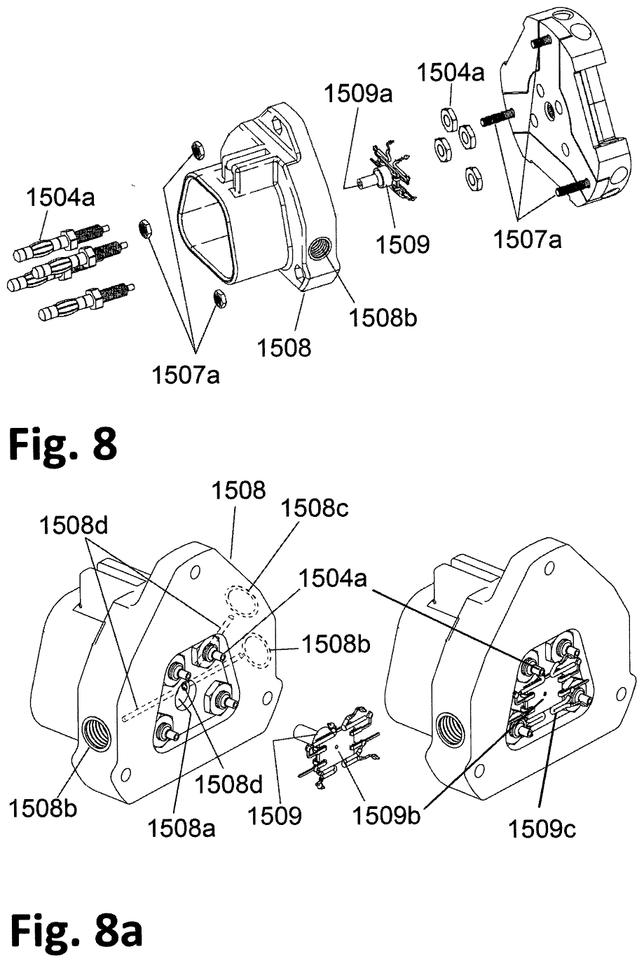

FIGS. 3, 4 and 5 show the tire pressure sensor unit 1501 of different viewing directions with the components visible from the outside, consisting of the fastening device 1505, the pressure sensor housing block 1508 with an integrated plug-in device 1504, consisting of four tuft pins 1504a, the fastening mechanism 1505, the three adhesion claws 1506 hinged to the mounting base 1507, horizontally folded out, and a latch 1504c for a snap lock, shown in FIG. 10a. The air pressure hoses 1502 or the pressure housing valve stem 1503, FIG. 2 are screwed into the three threaded holes 1508b and 1508c, FIG. 8a.

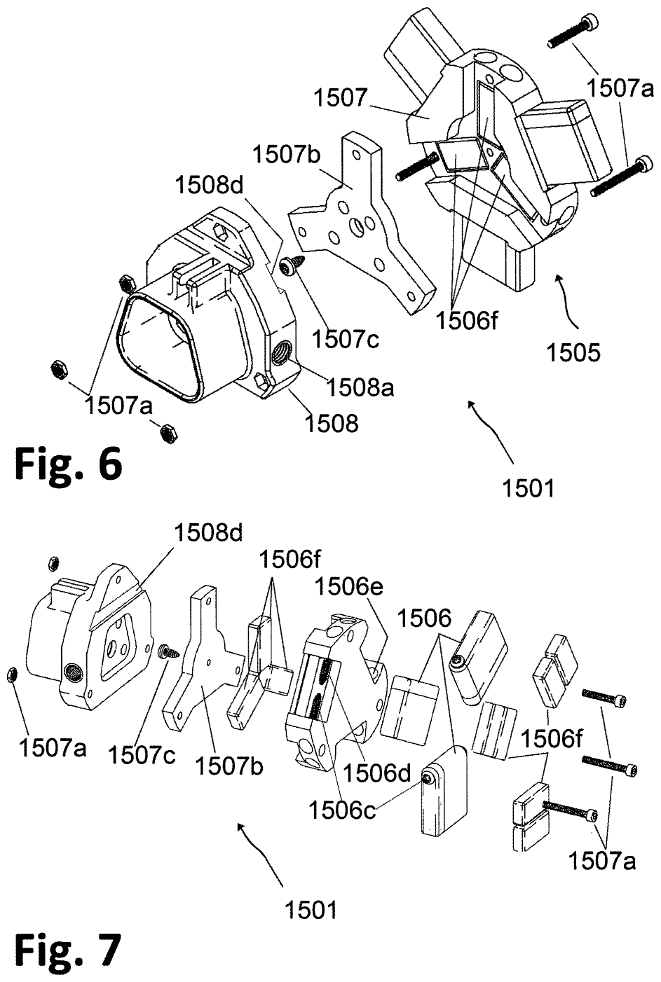

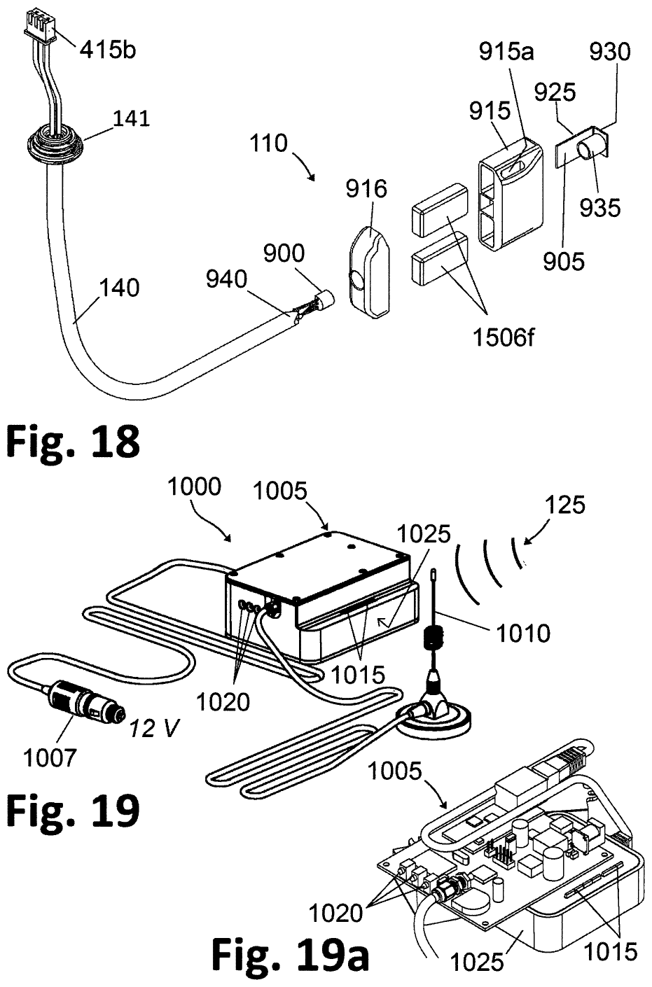

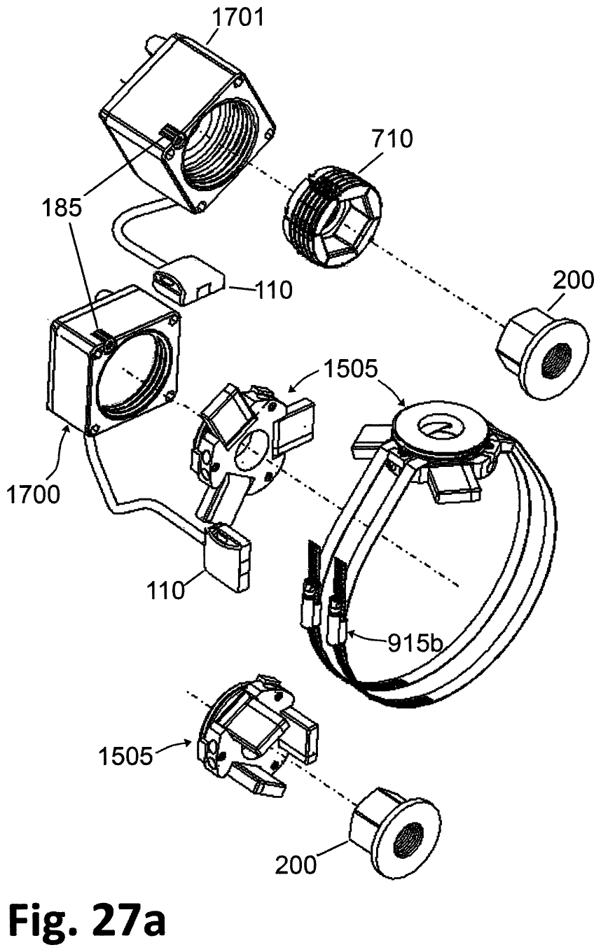

FIG. 6 shows a perspective view of a pressure sensor housing block 1508 separated from the fastening mechanism 1505 with three exposed magnets 15061 in the centre, according to one exemplary embodiment. This can be the tire pressure sensor unit described in one of the preceding figures. The fasting mechanism 1505 shown in FIG. 6 has been removed from the pressure sensor housing block 1508 by pulling out the connecting bolts 1507a and shows a groove 1508d in FIG. 6 and FIG. 7, which forms a through-channel 915a with pressure sensor housing block 1508, when bolted together, which can be seen in FIG. 18 providing a through-channel 915a and is also referred to below as a channel, hole recess, cable tie recess or cable tie through hole. This through-channel 915a is for a binding strap 915b, e.g. cable tie in FIG. 24 g or hose clamp, FIGS. 27 and 27a, or similar loop ties, and positively secures against the centrifugal force when being attached e.g. onto the hub sleeve, as shown in FIG. 24g, FIGS. 27 and 27a.

The fastening device 1505, which magnetically adheres semi-permanently to the hub and is optionally removed only occasionally, for example during wheel changes, in order to protect it from possible damage, can be fastened to non-magnetic metal hubs or plastic surfaces by applying a double-sided industrial foam adhesive tape or a non-permanent adhesive compound to the magnetic surfaces in order to achieve an adhesion similar to the magnetic force. The two air pressure hoses 1502 and the cable of the sensor unit 110 shown in FIG. 2 restrain the adopted position from dislocating.

FIG. 7 shows a perspective view of a disassembled tire pressure sensor unit 1501 according to an exemplary embodiment. This may be the tire pressure sensor unit 1501 described in one of the preceding figures.

FIG. 8 shows a perspective view of the pressure sensor housing block 1508 with the pressure sensor 1509 exposed, according to one exemplary embodiment. This may be the pressure sensor housing block 1508 described in one of the preceding figures.

In FIG. 6, FIG. 7 and FIG. 8, the pressure sensor housing block 1508 and the fastening mechanism 1505 are shown disassembled. Therefore the view discloses the pressure sensor 1509 in FIG. 8 and FIG. 8a, otherwise embedded in the pressure sensor housing block 1508 and three connecting bolts 1507a in FIG. 6, FIG. 7 and FIG. 8 mounting the pressure sensor housing block 1508 to the fastening mechanism 1505. A cover 1507b, which holds three neodymium magnets 1506f embedded in the mounting base 1507 in place with a cutting screw 1507c. In various embodiments, this cover arrangement is also used for various similar fastening mechanisms.

FIG. 8a shows a perspective illustration of a pressure sensor housing block 1508 with an exposed pressure chamber 1508a, according to an exemplary embodiment. This may be the pressure sensor housing block 1508 described in one of the preceding figures. The pressure sensor 1509, FIG. 8 is being inserted into the pressure sensor housing block 1508 and is connected with its soldering tabs via short solder-heat-dissipating connecting wires 1509c to the associated tuft pin connectors and subsequently cast in a pressure-air-tight manner with synthetic resin. The pressure receiving tube hole 1509a of the pressure sensor 1509 shown in FIG. 8 is exposed to the tire pressure by the three connecting bore-holes 1508d, shown in dashed lines in FIG. 8a, via the air hoses 1502 and valve stems 1503, FIG. 1, FIG. 1a screwed into the threaded holes. The pressure sensor 1509 receives the required current from the docked transmission unit via two of the four tuft pins and conducts the analogue measurement data of the tire pressures of the twin tires, which are combined in the pressure sensor housing block 1508 and thus balanced, to the printed circuit board 415, FIG. 11 and FIG. 11a in the interior of the docked transmission unit 115, FIG. 1 via the two other tuft pins. The pressure equalization hole 1509b of the pressure sensor 1509 in FIG. 8a must not become clogged during casting with synthetic resin, as it is the required connection to the atmospheric air pressure via the non-air-tight bolted connection with the fastening device 1505.

Both tires are inflated simultaneously via the valve in the pressure housing valve stem 1503, FIG. 2. The balanced pressure in both tires has the advantage that the wear of the tires takes place uniformly and thus the tires are conserved, which is not the case with different pressures of separate twin tires.

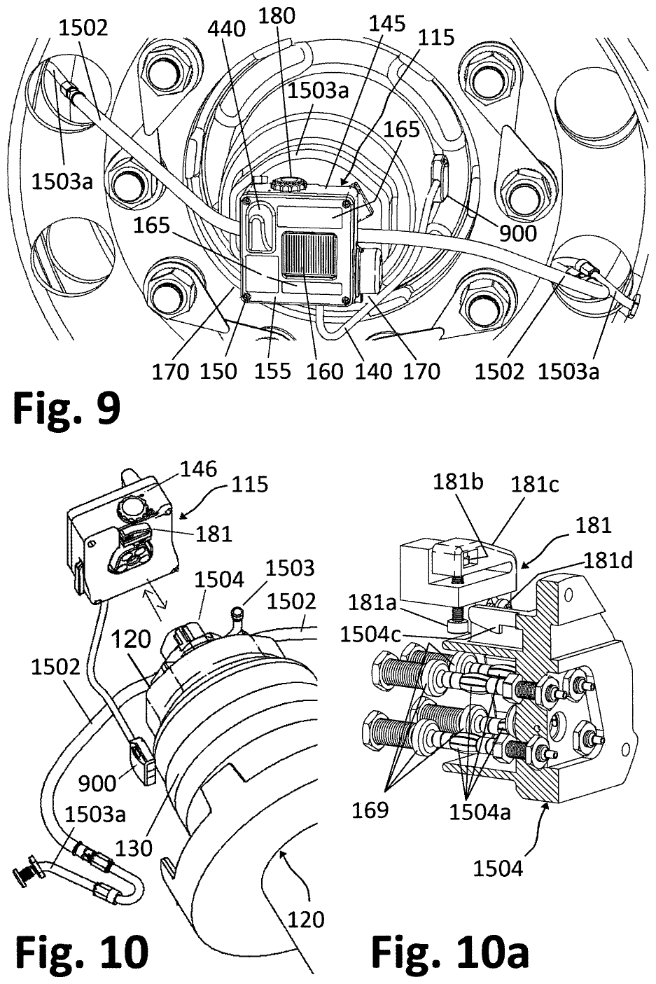

FIG. 9 shows a perspective view of the plugged-in transmission unit 115 according to an exemplary embodiment, as shown in FIG. 1, but greatly enlarged and therefore more detailed.

If a twin wheel is damaged, the pressure in both tires decreases simultaneously, the alarm is triggered in the driver's cab and the relevant wheel is displayed. The two air hoses 1502 are unscrewed. When unscrewing, the tire valves kept open by the screw connection of the air pressure hoses 1502 close automatically. The damaged twin wheel is being recognized by the fact that it continues to lose air and can be exchanged.

FIG. 10 shows a perspective illustration of the transmitting unit 115, pulled away from the tire pressure sensor unit 1501, which magnetically adheres to the wheel hub 120, illustrated in accordance with an exemplary embodiment. This may be the monitoring device described in one of the preceding figures.

FIG. 10a shows a perspective illustration of a plug-in device 1504 with a snap lock 181, shown in accordance with an exemplary embodiment. This can be the snap lock 181 described in FIG. 1, which can also be referred to as a snap-in plug-in device. In the case of a wheel exchange, the transmitting unit, shown in FIG. 10, is unlocked by exerting thumb pressure on the springy lever 181c of the snap lock 181, adjustably via the locking screw 181a and the stop nut 181b restrained by the six edges, and the pressure-housing plug-in device 1504 is pulled away together with the magnetic temperature sensor 110. The power supply and the data exchange via the four tuft pins 1504a and the four pin-sockets 169 are thus also interrupted, illustrated in the cut-open detail, FIG. 10a. The tire pressure sensor unit 1501 is also stripped after the two compressed air hoses 1502 are unscrewed from the two wheel valve stems 1503a.

After the damaged wheel is replaced by a fully pumped spare wheel and the tire pressure sensor unit 1501 is again connected to the tire valves 1503a, FIG. 10 via the compressed air hoses 1502, the spare wheel pumps up the undamaged wheel until the tire pressure has equalized.

A motor vehicle train has compressed air available and both tires are inflated by the vehicle driver via the pressure housing valve stem 1503 one shown in FIG. 10 until the wheel, again connected to the system, displays the correct tire pressure on the output unit 1100, FIG. brought along from the driver's cab to the repair point.

FIG. 11 shows a perspective rear top illustration of a transmitting unit 115 with all components viewing direction away from the wheel, according to an exemplary embodiment. This may be the transmission unit 115 described in one of the preceding figures. Shown is here beside other features the wedge-shaped retaining rail 170a described in FIG. 2.

FIG. 11a shows a perspective view of a transmitting unit 115 with all components from the front, with the direction of view towards the wheel, according to an exemplary embodiment. This may be the transmission unit 115 described in FIG. 11. In FIG. 11a, which shows all the components from the front, a seal 450 required for a gas-tight and thus ignition-source-free design. In addition, it is necessary for an explosion-proof design that the charging and voltage control port 505 is cast in its housing seat 505a in a gas-tight manner with synthetic resin. In addition to explosion protection, the screw cap 180 in FIG. 11 and FIG. 11a is provided with a sealing ring 180b. Self-opening is prevented by the cutting screw 180a shown in FIG. 11.

The three series-connected NiMH batteries 420 in size AA are constantly maintained in a full state of charge by the solar cell 160 under normal use in daylight. For underground operation, the batteries are charged via the charging and voltage control port 505. The power consumption depends on the programming of the selected signal intervals per hour. In the case of the exemplary embodiments and maximum consumption, a full charge lasts at least 4 weeks, according to experience.

Axle hubs have an average working temperature of 45 degrees Celsius and thus heat the batteries of a transmitting unit 115 in cold climate zones when fastened to the hub, so that use of the monitoring device in climate zones around the polar circuit is also possible in winter.

The solar cell 160 in FIG. 11 and FIG. 11a is protected in a gas-tight manner against damage by air borne rocks flung against the solar cover 155 by a protective pane 161. Nevertheless, if a possible short circuit is produced by damage, the diode 160b blocks a current flow. All electrical components can be replaced in a maintenance-friendly manner by their pinned connections. The four sockets 169, which are screwed in the transmission unit housing 145, are sealed in a gas-tight manner in the inner frame 145a. The temperature sensor unit 110, which can also be referred to as a “sensor unit for wheel hub temperature”, is screwed into the threaded hole 145b in a gas-tight manner by the seal ring 450 of the transmission unit housing 145 by means of the threaded cable gland 141 which is casted onto the cable. The antenna coil 435, soldered to the printed circuit board 415 via a shielded cable, is plugged into one of the three antenna directional holes 435a of the antenna bulge 440. By screwing the printed circuit board 415 to the solar cover 155 with three cutting screws 4151 via the fastening holes 415e, both the solar cell 160 in the holding frame 155a of the solar cover 155 and the antenna coil 435 in one of the three antenna holes 435a are held in place, FIG. 11a. The three antenna holes 435a are each offset 30 degrees to allow optimum antenna alignment corresponding to the positioning of the temperature and/or tire pressure transmitting unit 115 on the wheel.

Circuit board sockets and component pin connections which belong together have identical designation numbers in FIG. 11 and FIG. 11a.

FIG. 12 shows a perspective view of a wheel with a permanent installed tachometer 121 at the hub cap end of the wheel hub by the manufacturer, which requires a possible adhesive attachment of the monitoring device to a wheel nut, if a constant readability is desired, according to an exemplary embodiment. The monitoring device can be one of the monitoring devices described in one of the preceding figures.

In order to know the kilometres a trailer travelled since its operation commenced, some hubs of trailers have a tachometer 121 installed in the hub cap. A monitoring device 100 mounted above it prevents the direct readability of the numbers and a unit must be raised against the magnetic force in order to make the numbers readable. As an option, according to this exemplary embodiment, a magnetic adhesion of the monitoring device 100 to the hexagonal surfaces of a wheel nut is provided; see also FIG. 13.

FIG. 13 shows a cut-open representation of a monitoring device on a wheel nut 200 with claw-encompassing adhesive fastening shown in detail, according to one exemplary embodiment. This may be the monitoring device described in FIG. 12. The hinged mechanism of the adhesion claws 1506 is dimensioned in such a way that it magnetically comprises a wheel nut 200 and the entire monitoring device can be pulled off against the magnetic force when the wheel is changed.

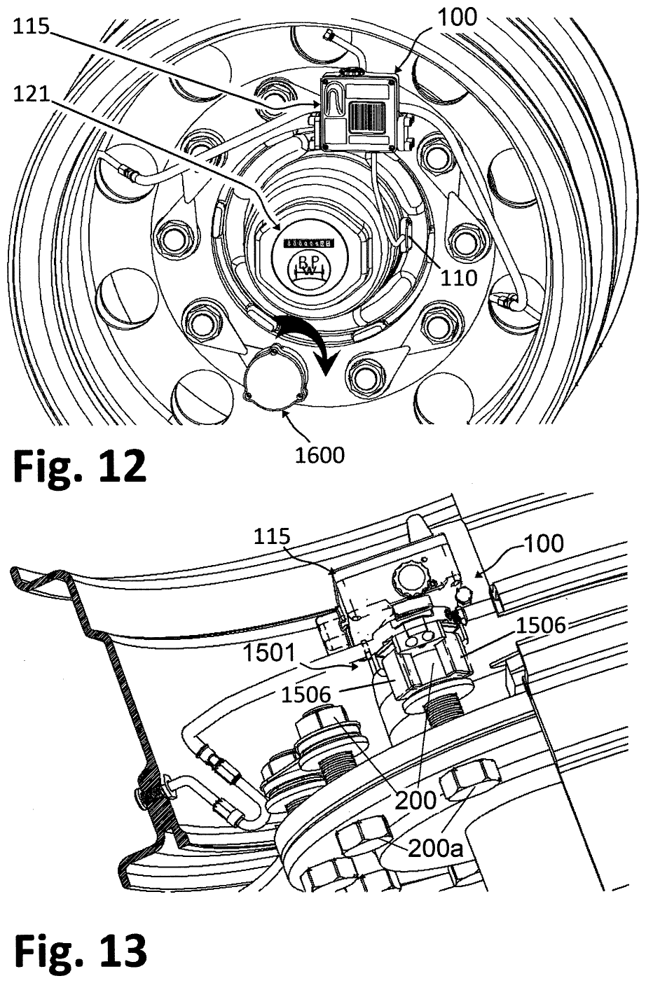

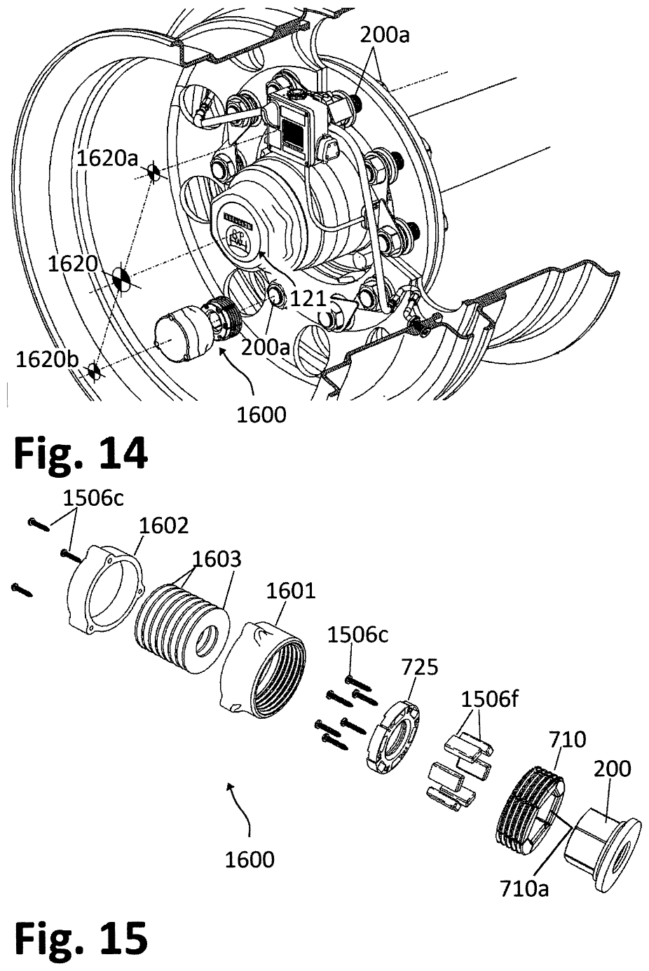

FIG. 14 shows a perspective view of a counterweight 1600 for balancing the resulting imbalance due to the attachment of the monitoring device to the wheel nut, according to an exemplary embodiment. This may be the monitoring device described in FIG. 12 or 13. Since off-centre attachment of the monitoring device 100 to the wheel produces an imbalance, which is corrected by a counterweight 1600, shown in FIG. 12, FIG. 14 and FIG. 15, balancing the bolt centre points 1620a and 1620b with respect to the centre of wheel rotation 1620 in FIG. 14.

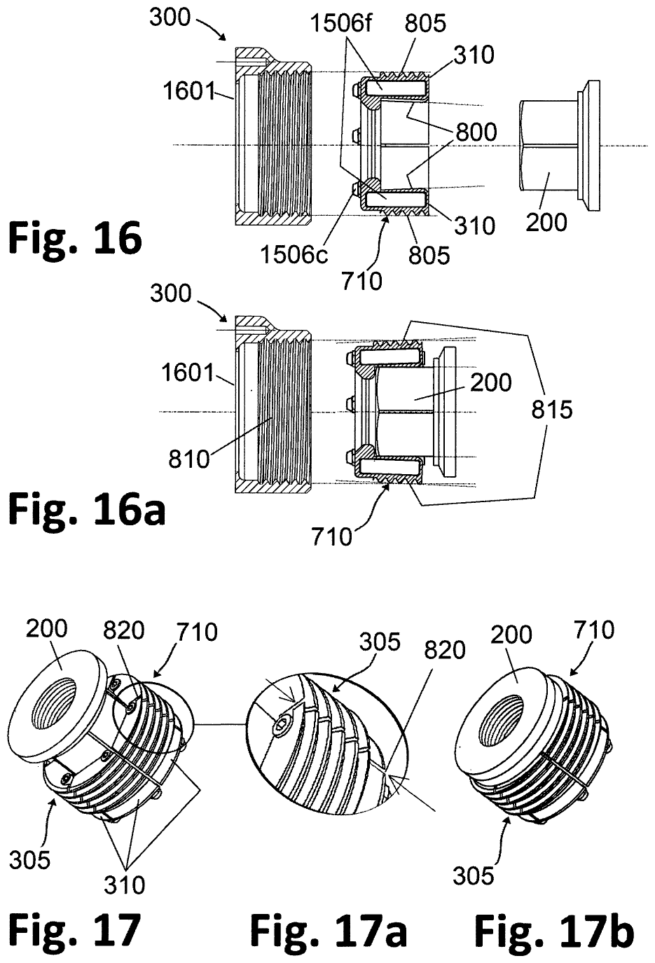

FIG. 15 shows a perspective view of a disassembled counterweight 1600 according to an exemplary embodiment, which may be the counterweight 1600 of the monitoring device described in FIGS. 12 to 14. The counterweight 1600 consists of a counterweight sleeve 1601 and counterweight cover 1602, into which the counterweight disks 1603, made of lead, are placed. These counterweight disks 1603 have a central hole which accommodates the thread overstand of a wheel bolt 200a projecting from the wheel nut 200, see FIG. 13. The counterweight 1600 according to this exemplary embodiment is locked to the nut with a fixing mechanism, for example a magnetic clamping device, the function of which is illustrated in FIG. 16, FIG. 16a and FIGS. 17, 17a and 17b.

FIG. 16 shows a lateral cross-sectional view of a fixing mechanism 300 of a counterweight according to an exemplary embodiment. This may be the fixing mechanism 300 described in FIG. 15, showing in a sectional illustration the functioning of the fixing mechanism 300 in the form of a clamping attachment also being magnetic in an unlocked state according to an exemplary embodiment.

According to this exemplary embodiment, the wheel nut 200 is shown outside clamping claws 310 of the fixing mechanism 300. According to this exemplary embodiment, flat inner walls 800 of the clamping claws 310 slope towards the cylinder axis of the cylindrical threaded part 710 of the mechanism device 300. As a result, the wall thickness of the clamping claws 310 increases in the direction towards the hub flange.

When the cylindrical threaded part 710 is pushed over the wheel nut 200, the six clamping claws 310 are spread apart in order to enclose the wheel nut 200. The clamping effect is produced in that a cylindrical external thread 805 of the clamping claws 310 is now conically shaped as a result of spreading over the wheel nut 200, since the inner walls 800 of the clamping claws 310 adapt to the hexagonal surfaces. The conical external thread is shown in FIG. 16a.

FIG. 16a shows a lateral cross-sectional view of a fixing mechanism 300 of a counterweight according to an exemplary embodiment. The fixing mechanism 300 described in FIG. 16 can be the fixing mechanism 300 described in FIG. 16, in which the wheel nut 200 is illustrated in a state being completely inserted into the clamping claws, that is to say clamped. A sectional illustration is shown of the functioning of the magnetic clamping attachment in the clamping state according to an exemplary embodiment.

When the counter-weight sleeve 1601 is screwed with its cylindrical internal thread 810 onto the now conical external thread 815 of the clamping claws, the hexagonal hole recess 710a, which is shown in FIG. 15, becomes increasingly narrowed with each rotation. Finally, the pressure of the surfaces on top of one another becomes so great that the counterweight 1600 cannot be pulled off without turning back.

FIG. 17 shows a perspective illustration of a fixing device according to an exemplary embodiment. The fixing mechanism described in FIG. 16 or in FIG. 16a can be in the form of a clamping mechanism 305. Shown is the threaded part 710 of the clamping mechanism 305. The wheel nut 200 is shown in a state partially inserted into the clamping claws 310. The threaded part 710 is slotted on six inner edges by incisions 820, so that the six clamping claws are formed which remain connected to one another at the screwed-in end.

By means of this exemplary embodiment the clamping mechanism 305, screwed on, exchangeable, and adapted to the wrench size of the wheel nut 200, according to this exemplary embodiment, a quick attachment or a rapid removal of the counterweight is achieved, whereby the clamping device 305, as per one exemplary embodiment exerts in the clamped state a primary magnetic clamping fixation on the wheel nut 200 and as a result of a thread tensioning or releasing rotational movement on the counter-weight sleeve 1601, see also FIG. 12, a secondary mechanical clamping effect is produced and additionally reinforces the magnetic clamping force, already sufficient enough for holding on, which now simultaneously locks it securely.

FIG. 17a shows a perspective view of a section of a clamping mechanism 305 according to an exemplary embodiment. This can be the clamping mechanism 305 described in FIG. 17, which shows an incision 820 in more detail.

FIG. 17b shows a perspective illustration of a clamping mechanism 305 with clamped wheel nut, according to one exemplary embodiment. This can be the clamping mechanism 305 described in FIG. 17, whereby the wheel nut 200 is completely inserted into the clamping claws, which is the clamped state.

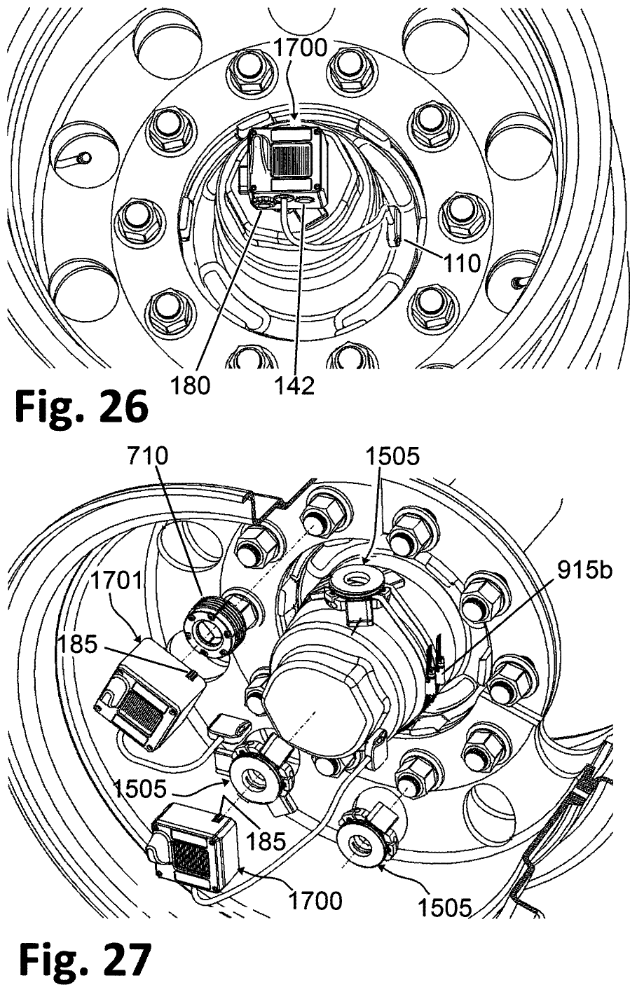

The mechanism of the clamping device 305 can also be used for fastening a unit housing, as shown in the exemplary embodiments in FIGS. 26 to 28a.

FIG. 18 shows a perspective view of a disassembled temperature sensor unit 110 of a monitoring device according to an exemplary embodiment. This can be the temperature sensor unit 110 described in FIG. 10, FIG. 11, FIG. 11a and FIG. 12, which is also referred to below as “sensor unit” in the following. According to this exemplary embodiment, the sensor unit 110 is formed as a temperature probe which is designed to sense a temperature as the physical parameter. According to this exemplary embodiment, the temperature probe comprises a programmable temperature sensor 900, a copper angle plate 905, magnets 1506f in the form of a neodymium magnet and/or a temperature sensor housing 915 with a housing cover 916. According to this exemplary embodiment, the sensor housing 915 is formed with a through channel 915a, which was described in FIG. 6. An optional cable tie can be pulled through the through channel 915a.

The temperature pickup takes place via the copper angle plate 905, which according to this exemplary embodiment receives the heat via one or both surfaces 925, 930 which are angled with respect to one another by two 90 degrees and transfers the heat to the temperature sensor 900. According to this exemplary embodiment, the temperature sensor 900 surrounded by an ferrule 935 on the angle plate 905 is cast with potting compound into the temperature sensor housing assembly 915 and 916 including cable end 940 of the flexible connecting cable 140, together with the two Neodymium magnets 1506f.

FIG. 19 shows a perspective illustration of an exemplary embodiment of a warning device 1000 for a vehicle. The warning device 1000 is designed to read the sensor signal 125 from one, or the sensor signals 125 simultaneously from a plurality of monitoring devices described in one of the preceding figures and, using the sensor signal 125, to produce an optical, acoustic and/or haptic output of the physical parameter on an output unit 1100, shown for example in FIG. 20. Furthermore, according to this exemplary embodiment, the warning device 1000 is designed to generate a warning signal shown in FIGS. 21 and 21a if the physical parameter reaches or falls below a defined threshold value. According to one exemplary embodiment, the defined threshold value represents a maximum temperature of, for example, 75 degrees Celsius at the wheel hub or two values for a predefined vehicle-related tire pressure range. According to one exemplary embodiment, the warning signal is designed to trigger an acoustically, optically and/or haptic warning for a person perceptible on the output unit 1100, for example. Furthermore, according to one exemplary embodiment, the warning device 1000 is designed to generate a further warning signal if the charging state information reaches or falls below a defined threshold battery charge value, whereby the threshold value, according to an exemplary embodiment, represents a low charging battery level of say 20 percent of the charging capacity of the rechargeable batteries, which is the energy storage device, for example.

A system from the warning device 1000 and the monitoring device can also be referred to as a warning system. According to this exemplary embodiment, the warning device 1000 has a base station 1005, a base station car plug 1007 and/or a further antenna 1010.

As soon as the base station 1005 receives a 12-volt vehicle current from the motor vehicle car battery power point and the driver has switched on the output unit 1100, for example in the form of a tablet shown in FIG. 20, the warning system begins to operate, according to this exemplary embodiment, recognizable on the illumination of WiFi-LEDs 1015 and/or transmission unit communication LEDs 1020. According to this exemplary embodiment, the software of the base station 1005 is run up after approximately 2 minutes, at the same time, according to this exemplary embodiment, the initialization of a modem 1025 in the interior of the base station 1005 commences and connects to output unit 1100 via WiFi according to this exemplary embodiment.

If the base station 1005 is switched off in the driver's cab by pulling out the base station car plug 1007, here in the form of a 12-volt universal plug, the transmitting units fall in sleep mode on all the wheels shown, for example, in FIG. 1 and FIG. 21. The radio contact of all transmission units, via the antennas thereof with the further antenna 1010, which is arranged, for example, on the roof of the driver's cab, is then shut down. As soon as the base station plug 1007 is inserted into the 12-volt vehicle socket again, the system powers up.

A description of an exemplary mode of operation of the warning system follows:

According to one exemplary embodiment, in pre-programmed time intervals, for example every two minutes, all transmission units of the monitoring device simultaneously transmit the current temperature and/or the tire pressure to the base station 1005, via their antennas to the cabin antenna 1010. The reading is carried out according to this exemplary embodiment on request of the base station 1005 in the pre-programmed default time interval of two minutes by the temperature probe described in FIG. 18, and by the tire pressure sensor unit 1501 described in FIG. 3. Both are designed to adhere by magnetic force, the one to a temperature-critical heat area on the wheel hub, the other centrally placed at the hub end. The modem 1025 in the base station 1005 transmits this data to the output unit 1100, FIG. 20. The software processes the data graphically and in various, easily understandable data representations on the output unit 1100, for example on the screen of a tablet 1100.

If the measured temperature of any of the measuring devices exceeds the pre-programmed permissible value of, for example, 75 degrees Celsius, a first alarm is triggered and the alarm causing wheel and/or its measured data appears on the screen. The driver now has sufficient time to stop and check the vehicle at a safe location. However, if the wheel is heats up rapidly, according to one exemplary embodiment, a second aggressive audible alarm sets in at a default temperature at, for example, 85 degrees Celsius. From this point in time stopping is absolutely necessary. In the event of a tire pressure drop, the system behaves similarly.

According to one exemplary embodiment, the software stores all measured values, which reach way back into the past and creates a measurement profile over this past period in time from the data of each individual wheel. This stored data is advantageous for the maintenance of the wheel bearings and the condition of the tires.

If the monitoring device/the monitoring system is travelling in a region covered by the mobile network, all current and historical data, according to one exemplary embodiment, are geographically accessible from anywhere via the Internet by logging into the software.

In short the base station 1005 is therefore designed, according to this exemplary embodiment, in order to forward the received physical parameters to a commercially available tablet screen which easily conveys the current temperature and/or the tire pressure state of the wheels to the driver, warns in time via audible visual and/or haptic alerts the driver of an imminent wheel fire hazard or of defective tires and points out the wheel from which a tire fire is imminent or a tire is defect.

FIG. 19a shows a perspective illustration of the components of a base station 1005 of a warning device according to an exemplary embodiment. According to this exemplary embodiment, an interior of the base station 1005 described in FIG. 19 is shown.

FIG. 20 shows an output unit 1100 for use with a warning system according to an exemplary embodiment. This may be the warning system described in FIG. 19. According to this exemplary embodiment, the output unit 1100 is arranged in a driver's cab of the vehicle, adjacent to a vehicle driver of the vehicle. According to one exemplary embodiment, the output unit 1100 is part of the warning system or, according to an alternative exemplary embodiment, is formed as a communication device already present in the vehicle.

According to this exemplary embodiment, the output unit 1100 has a display, a loudspeaker and/or a movable device, for example a vibration-capable device. According to this exemplary embodiment, the output unit 1100 displays a plurality of temperatures and/or tire pressures for a plurality of wheels of the vehicle equipped with measuring devices using a plurality of sensor signals.

According to an alternative exemplary embodiment, an instantaneous state of charge of each individual accumulator of the monitoring device is also displayed on the output unit 1100 using the sensor signals and/or an acoustic signal and/or appears to be an optical signal if the state of charge of the rechargeable batteries becomes questionable, for example only 20 percent of its charging capacity or less.

In other words, FIG. 20 shows a left hand traffic road train driver's cab with output unit 1100 in the form of a warning system tablet screen.

FIG. 21 shows a schematic plan view of a vehicle 1200 with a monitoring device according to an exemplary embodiment. This may be the monitoring device described in one of the preceding figures.

According to this exemplary embodiment, the monitoring device has at least one second measuring device with a second sensor unit, which is designed to sense a second physical parameter in the region of the second wheel in a coupling position on a first section of a wheel hub of a second wheel of the vehicle 1200 during travel of the vehicle 1200, and with a second transmitting unit which has a second fastening device which is formed in order to fasten the second transmitting unit in a fastening position on a second section or a second wheel rim of the second wheel, wherein the second transmitting unit is designed to wirelessly transmit a second sensor signal representing the second physical parameter to the warning device in order to enable monitoring of the second physical parameter. According to one exemplary embodiment, the second measuring device and the measuring device are of identical design and/or whereby each wheel of the vehicle 1200 has such a measuring device.

In other words, FIG. 21 shows a road train with warning device placements. The vehicle 1200, according to this exemplary embodiment, is formed as a typical 53.5 meter of long road train for ammonium nitrate, a hazardous material of the transport class 5.1, consisting of six vehicle components with continuous numbering of 44 wheels, whereby the right-hand wheel No 34 at the second last trailer, according to this exemplary embodiment, by sudden heating up from normal 45 degrees Celsius to 75 degrees Celsius on the warning device, has triggered the warning signal 1205 in form of a first default alarm in the driver's cab. According to one exemplary embodiment, when heated to 85 degrees Celsius, a second warning signal in the form of a second default alarm is triggered in the driver's cab, which is signalling an even more urgent alarm stage.

FIG. 21a shows a schematic side view of a vehicle 1200 with a monitoring device according to an exemplary embodiment. This may be the vehicle 1200 described in FIG. 21.

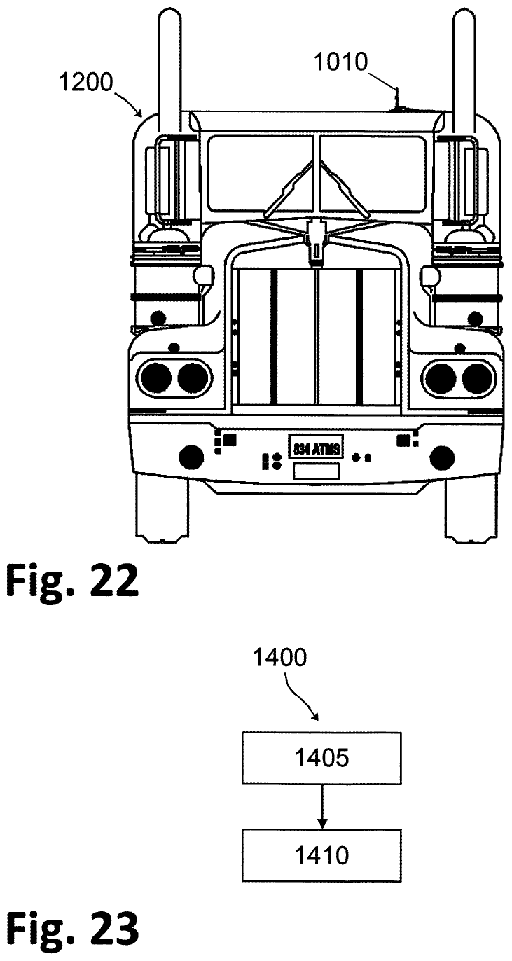

FIG. 22 shows a schematic representation of a vehicle 1200 with a warning system, according to an exemplary embodiment. This may be the warning system described in FIG. 19. The vehicle 1200 is shown in front view.

According to this exemplary embodiment, the further antenna 1010 is positioned on a roof of the vehicle 1200 which, according to this exemplary embodiment, is designed as a road-train prime mover.

FIG. 23 shows a flow chart of a method 1400 according to an exemplary embodiment for operating a monitoring device. This may be one of the monitoring devices described in one of the preceding figures.

The method 1400 includes a step of sensing 1405 and a step of transmitting 1410. In step of sensing 1405, the temperature, for example the wheel hub temperature, is sensed in the region of the wheel using the temperature sensor unit, which is at least partially fastened to the wheel hub, during travel of the vehicle and is provided to the transmitting unit. Additionally or alternatively, in step of sensing 1405, the tire pressure of at least one wheel tire of a wheel is sensed using the tire pressure sensor unit which is releasable attached in the attachment position on one or more locations of the wheel hub of the wheel, hub sleeve of the wheel, wheel rim, and/or wheel nut of the vehicle, in particular whereby, in step of sensing 1405, the electrical energy is obtained from the transmitter unit placed externally onto the tire pressure sensor unit. In step of transmission 1410, the sensor signal representing the tire pressure and/or the temperature is transmitted using the transmitting unit, which is fastened to the wheel hub or the wheel rim of the wheel or the tire pressure sensor unit in a spontaneously releasable manner to enable monitoring of the wheel hub temperature and/or the tire pressure.

The method steps presented here can be repeated, as well as in a different order than described in the described order.

FIG. 24 shows a fastening mechanism 1505 of a monitoring device according to an exemplary embodiment. This may be an exemplary embodiment of the fastening mechanism 1505 described in one of the preceding figures.

FIGS. 24 and 24a to 24g each show an adaptation of the fastening mechanism to different surface shapes by means of articulated forming. Since hubs and rims of various manufacturers differ, mounting possibilities are shown in FIGS. 24 to 24g in which the magnetic adhesion claws 1506 adapt to the different shapes of the fastening surfaces of rims or hubs, whereby in FIG. 24 the fastening mechanism 1505 adheres magnetically via the three claws 1506 onto the sides of a wheel nut 200 and in this exemplary embodiment the protruding wheel bolt penetrates into the hole recess 1507d of the mounting base 1507, referred to in FIG. 24c.

FIG. 24a shows a fastening mechanism 1505 of a monitoring device according to an exemplary embodiment. This can be the fastening mechanism 1505 described in FIG. 24, with the difference that the fastening mechanism 1505 according to this exemplary embodiment is fastened to a flat adhesive surface.

FIG. 24b shows a fastening mechanism 1505 of a monitoring device according to an exemplary embodiment. This can be the fastening device 1505 described in FIG. 24, with the difference that the fastening mechanism 1505 according to this exemplary embodiment is fastened to a convex adhesive surface.

FIG. 24c shows a fastening mechanism 1505 of a monitoring device according to an exemplary embodiment. This can be the fastening mechanism 1505 described in FIG. 24, with the difference that the fastening mechanism 1505 according to this exemplary embodiment is fastened to a conical adhesive surface.

FIG. 24d shows a fastening mechanism 1505 of a monitoring device according to an exemplary embodiment. This can be the fastening device 1505 described in FIG. 24, with the difference that the fastening mechanism 1505 according to this exemplary embodiment, is fastened to a concave adhesive surface.

FIG. 24e shows a fastening mechanism 1505 of a monitoring device according to an exemplary embodiment. This can be the fastening mechanism 1505 described in FIG. 24, with the difference that the fastening mechanism 1505 according to this exemplary embodiment is fastened to an angled adhesive surface.

FIG. 24f shows a fastening mechanism 1505 of a monitoring device according to an exemplary embodiment. This can be the fastening mechanism 1505 described in FIG. 24, with the difference that the fastening mechanism 1505 according to this exemplary embodiment is fastened to a cylindrical adhesive surface.

FIG. 24g shows a fastening mechanism 1505 of a monitoring device according to an exemplary embodiment. This can be the fastening mechanism 1505 described in FIG. 24, with the difference that the fastening mechanism 1505 according to this exemplary embodiment further comprises a binding device. The tire pressure sensor unit 1501 is shown magnetically adhesively attached to a wheel hub sleeve and to a binding strap 915b, which is pulled through the rectangular cable tie through channel 915a, thereby looping around the wheel hub and thus preventing the tire pressure sensor unit 1501 from being thrown off as a result of the centrifugal force.

FIG. 25 shows a perspective illustration of a monitoring device according to an exemplary embodiment. This may be the monitoring device described in one of the preceding figures, which according to this exemplary embodiment is formed for a single wheel. According to this exemplary embodiment, the transmitting unit 115 houses a permanently installed tire pressure sensor unit 1501 and a permanently installed temperature sensor unit 110 for hub temperature and/or is formed very flat since, in the case of individual wheels, the wheel hub penetrates as far as the rim edge. This embodiment occurs mainly in the case of steering wheel axle hubs. FIG. 1 shows a perspective view of an extra flat design of the monitoring device for steering wheels with an integrated wheel hub temperature and tire pressure sensor unit, according to an exemplary embodiment.

FIG. 25a shows a perspective illustration of a monitoring device according to an exemplary embodiment. This can be the flat-shaped monitoring device for a single wheel described in FIG. 25, here with the direction of view along a steering axle wheel, in order to emphasize that the housing of the transmission unit 115 for pressure and temperature with integrated tire pressure sensor unit 1501 does not protrude beyond the wheel bolts.

FIG. 26 shows a monitoring device according to an exemplary embodiment. This can be the monitoring device described in one of the preceding figures, with the difference that the monitoring device according to this exemplary embodiment has a flat wheel hub temperature measuring unit 1700, the flatter of two embodiments and better suited for the wheel hub end, which, however, protrudes further than other regions on the wheel. The flat wheel hub temperature measuring unit 1700 comprises, according to this exemplary embodiment, the transmitting unit and a temperature monitoring using the temperature sensor unit 110. The flat wheel hub temperature measuring unit 1700 is designed for additional monitoring of the tire pressure. In order to be able to monitor the tire pressure, the flat wheel hub temperature measuring unit 1700 can be upgraded. A threaded protection cover 142 of the wheel hub temperature measuring unit 1700 is removed for this purpose and a tire pressure data socket plug for the data cable 1504d is used, which is functionally shown in FIG. 28a on the deep shaped wheel hub temperature measuring unit 1701 and is illustrated in detail in FIG. 4a.

FIG. 27 shows a monitoring device according to an exemplary embodiment. This can be the monitoring device described in FIG. 26, with the difference that the monitoring device additionally or alternatively to the flat wheel hub temperature measuring unit 1700 has at least one deep wheel hub temperature measuring unit 1701. Also, the deep wheel hub temperature measuring unit 1701 features, according to this exemplary embodiment, the transmitting unit and a temperature monitoring device using the temperature sensor unit 110. The two different wheel hub temperature measuring units 1700, 1701 are each configured for additional monitoring of the tire pressure in a flat design, in particular for attachment at the hub end with a claw fastening mechanism and a deeper embodiment for attachment with a clamp mechanism for fastening. The clamping attachment mechanism may be the fixing device shown in FIG. 14 to FIG. 17. The deep wheel hub temperature measuring unit 1701 in FIGS. 27 and 27a, FIGS. 28 and 28a, is formed somewhat deeper in order to be able to accommodate a threaded part 710 identical to the fastening of the counterweight to the wheel nut, already described in FIGS. 16 and 17.

Since all electronic components are provided with pinned connections, expansion components are merely supplemented or replaced.

The fastening mechanism 1505 is used for fastening the flat shaped wheel hub temperature measuring unit 1700. Fastening possibilities, as already shown schematically in FIG. 24, FIGS. 24a-24 g, are shown here by the mainly occurring cases in FIGS. 27 and 27a. Since the deep wheel hub temperature measuring unit 1701 can also be screwed onto the short thread of the fastening device 1505, this embodiment has the same locking wheel 185 as the flat wheel hub temperature measuring unit 1700. By rotating, the roller-shaped locking wheel 185 it advances in the direction of the fastening device 1505 and prevents the measuring unit from turning lose by moving between parts of the fastening device 1505.

FIG. 27a shows a monitoring device according to an exemplary embodiment. This may be the monitoring device described in FIG. 27. The options of the attachment are shown: at the wheel hub end and on the hub sleeve, wherein no significant imbalance arises, and on the wheel nut 200, wherein, depending on the driving speed, a balancing counterweight 1600 is to be attached.

FIG. 28 shows a perspective illustration of a deep embodied wheel hub temperature measuring unit 1701 according to an exemplary embodiment. This can be the deep embodied wheel hub temperature measuring unit 1701 described in FIG. 27 or 27a, which can also be referred to as a temperature transmitting unit and which can be upgraded for additional tire pressure monitoring with magnetic clamping attachment to the wheel nut. The deep embodied wheel hub temperature measuring unit 1701 with screwed-in threaded part 710 (not-invisible) is the upgradable temperature monitoring and transmitting unit fastened by the clamping mechanism and therefore in a deeper embodiment for future upgrade in monitoring the tire pressure.

FIG. 28a shows a perspective view of a deep embodied wheel hub temperature measuring unit according to an exemplary embodiment. This can be the deep embodied wheel hub temperature measuring unit described in FIG. 27, 27a or 28, which is now equipped with additional monitoring of the tire pressure and therefore according to this exemplary embodiment is referred to as a temperature monitoring transmitter unit 1702. The temperature monitoring transmitter unit 1702 is equipped for additional tire pressure monitoring with a magnetic clamping attachment to the wheel nut and fastening of the tire pressure sensor unit 1501 with the fastening mechanism 1505, which in the first instance, instead of a cable connection 1504d, is used for the pluggable monitoring and transmitting unit 115 regarding wheel hub temperature and tire pressure.

If an exemplary embodiment comprises an “and/or” connection between a first and a second feature, this can be read in such a way that the exemplary embodiment according to one embodiment has both the first feature and the second feature and, according to a further embodiment, either only the first feature or only the second feature.

### LIST OF REFERENCE SIGNS

100 Monitoring device
110 Temperature sensor unit
115 Transmission unit
120 Wheel hub
121 Tachometer
122 Wheel rim
125 Sensor signal
130 Hub sleeve
140 Flexible connecting cable
141 Threaded cable bushing
142 Protection cover
145 Transmission unit housing
145a Inner frame
145b Threaded hole
146 Control light
150 Housing screw
155 Solar cover
155a Holding frame
160 Solar cell
160a Plug-in connection solar cell
160b Diode
161 Protective Pane
162 Holding frame for solar cell
165 Adhesive recess
169 Pin-socket
170a Retaining rail for protective cap
180 Screw cap
180a Securing screw
180b Seal ring
181 Snap lock
181a Locking screw
181b Stop nut
181c Springy lever
181d Mounting screw
181e Lock installation groove
185 Locking wheel
200 Wheel nut
200a Wheel bolt
300 Fixing mechanism
305 Clamping mechanism
310 Clamping claw
415 Printed circuit board
415a Plug-in connections battery current
415b Plug-in connection Hub temperature
415c Plug-in connection tire pressure
415d Programming connection
415e Fastening hole
4151 Cutting screw
420 NiMH battery
435 Antenna coil
435a Antenna hole
440 Antenna bulge
450 Seal ring
505 Charging and voltage control port
505a Housing seat
710 Threaded part
710a Hexagonal hole recess
800 Inner wall
805 Cylindrical external thread
810 Cylindrical internal thread
815 Conical external thread
820 Incision
900 Temperature sensor
905 Angle plate
915 Temperature sensor housing
915a Through-channel
915b Binding strap
916 Housing cover
925 Surface horizontal
930 Surface vertical
935 Ferrule
940 Cable end
1000 Warning device
1005 Base station
1007 Base station car plug
1010 Further antenna
1015 WiFi-LEDs
1020 Broadcast unit communication LEDs
1025 Modem
1100 Output unit
1200 Vehicle
1205 Warning signal
1400 A method for operating a monitoring device
1405 Step of Sensing
1410 Step of sending
1501 Tire pressure sensor unit
1502 Air pressure hose
1503 Valve stem
1503a Valve stem
1504 Plug-in device
1504a Tuft pin
1504b Protective cap
1504c Latch
1504d Cable plug connection
1505 Fastening mechanism
1506 Adhesion claw
1506a Claw housing
1506b Claw housing cover
1506c Cutting screw
1506d Cutting screw
1506e Bearing hole
1506f Neodymium magnet
1507 Mounting base
1507a Connecting bolts
1507b Magnet cover
1507c Cutting screw for magnetic cover
1507d Hole recess
1508 Pressure sensor housing block
1508a Pressure chamber
1508b Threaded hole pressure hose
1508c Threaded Hole Valve Connector
1508d Bore-hole
1509 Pressure sensor
1509a Pressure receiving tube hole
1509b Pressure equalization hole
1509c Connecting wires
1511 Pressure housing
1600 Counterweight
1601 Counter-weight sleeve
1602 Counter-weight cover
1603 Counter-weight disk
1620 Centre of wheel rotation
1620a Centre point upper wheel bolts
1620b Centre point lower wheel bolt
1700b Flat wheel hub temperature measurement unit
1701 Deep wheel hub temperature measuring unit
1702 Temperature monitoring transmitter unit

1. A monitoring device (100) for a vehicle (1200), the monitoring device (100) comprising at least one measuring device having the following features:
a tire pressure sensor unit (1501), which is designed to sense a tire pressure of at least one wheel tire of a wheel of the vehicle (1200), in particular wherein the tire pressure sensor unit (1501) is designed to draw electrical energy from a transmission unit (115) which is arranged externally and/or spontaneously detachable from the tire pressure sensor unit (1501) and/or to output data transmitted thereto, wherein the tire pressure sensor unit (1501) comprises a fastening device (1505) configured to releasable fasten the tire pressure sensor unit (1501) in a fastening position on one or more portions of a wheel hub (120) of the wheel, a hub sleeve (130) of the wheel, a wheel rim (122), a wheel nut (200) of the vehicle (1200), and/or wherein the transmitting unit (115) is spontaneously releasable attached to the tire pressure sensor unit (1501);
and/or a temperature sensor unit (110) configured to be at least partially attachable to the wheel hub (120) and to sense a temperature in the region of the wheel during travel of the vehicle (1200) and to provide it to the transmitting unit (115); and
the transmission unit (115), which can be detachable fastened to the wheel hub (120) of the wheel, the wheel rim (122) or the tire pressure sensor unit (1501), in particular wherein the transmitting unit (115) is designed to emit wireless a sensor signal (125) representing the tire pressure and/or the temperature in order to enable monitoring of the tire pressure and/or the temperature.

2. Monitoring device (100) according to one of the preceding claims, in which at least one region of the fastening device (1505) has at least one magnet in order to magnetically and/or a binding device the tire pressure sensor unit (1501) in order to fasten the tire pressure sensor unit (1501) to the wheel hub (120), hub sleeve (130), wheel rim (122) and/or wheel nut (200).

3. Monitoring device (100) according to one of the preceding claims, wherein the fastening device (1505) comprises parts which are shaped to be fastened to a wheel surface of the wheel.

4. Monitoring device (100) according to claim 3, in which the parts are mounted movable, as finger-like holding or adhesion claws (1506) and/or magnetically shaped.

5. Monitoring device (100) according to one of the preceding claims, in which the fastening device (1505) adjoins a pressure housing (1511), in the interior of which a pressure sensor (1509) is located.

6. The monitoring device (100) of claim 5, wherein the pressure sensor (1509) is connected or connectable to a hose (1502) via a wheel valve stem (1503a) of at least one wheel tire of the wheel to sense the pressure of at least this wheel.

7. Monitoring device (100) according to one of claim 5 or 6, in which the pressure sensor (1509) is or can be connected to one of at least two wheel tires each by a hose (1502) each having a wheel valve stem (1503a), in particular wherein the pressure sensor (1509) is designed to sense a tire pressure equalizing between at least these two wheel tires.

8. Monitoring device (100) according to one of claim 6 or 7, which has at least one pressure housing valve stem (1503) via which air can be supplied to at least one wheel tyre.

9. Monitoring device (100) according to one of the preceding claims, having a data cable (1504) between the tire pressure sensor unit (1501) and the transmitting unit (115), wherein the tire pressure sensor unit (1501) is designed to transmit a sensor data signal representing the tire pressure to the transmission unit (115) via the data cable (1504), and/or the transmitting unit (115) is designed to output electrical energy via the data cable (1504) to the tire pressure sensor unit (1501).

10. Monitoring device (100) according to one of the preceding claims, having a plug-in device (1504) which is designed to detachably couple the tire pressure sensor unit (1501) and/or the temperature sensor unit (110) to the transmitting unit (115), in particular wherein the plug-in device (1504) is formed as a self-locking plug-in device (1504).

11. Warning system having a monitoring device (100) according to one of the preceding claims and a warning device (1000) which is designed to receive the sensor signal (125) and to generate a warning signal (1205) if the tire pressure reaches or exceeds a defined threshold value and/or the temperature reaches or exceeds a defined threshold value.

12. A method (1400) of operating a monitoring device (100) according to any one of claims 1 to 10, the method comprising the steps of:
sensing (1405) the tire pressure of at least one wheel tire of a wheel using the tire pressure sensor unit (1501) releasably secured in the attachment position to the one or more portions of the wheel hub (120) of the wheel, hub sleeve (130) of the wheel, wheel rim (122) and/or wheel nut (200) of the vehicle (1200), and/or wherein the tire pressure sensor unit (1501) is releasably attached to the transmitting unit (115), in particular wherein, in the sensing step, the electrical energy is obtained from the transmitter unit (115) arranged externally by the tire pressure sensor unit (1501); and/or
sensing (1405) the temperature in the region of the wheel using a temperature sensor unit (110) at least partially attached to the wheel hub (120) during travel of the vehicle (1200) and providing the temperature to the transmitting unit (115); and
transmitting (1410) the sensor signal (125) representing the tire pressure and/or the temperature using the transmitting unit (115) that is spontaneously releasably attached to the wheel hub (120) or the wheel rim (122) of the wheel or the tire pressure sensor unit (1501) to enable monitoring of the tire pressure and/or the temperature.
